(19) United States
(12) Patent Application Publication
(10) Pub. No.: US 2024/0386831 A1
(43) Pub. Date: Nov. 21, 2024

(54) DISPLAY APPARATUS FOR DOG

(71) Applicant: SUNNY WAVE TECH CO., LTD., Ulsan (KR)

(72) Inventors: Bonghyun YOU, Seoul (KR); Heejin KANG, Hwaseong-si (KR); Tami KIM, Seoul (KR)

(73) Assignee: SUNNY WAVE TECH CO., LTD., Ulsan (KR)

(21) Appl. No.: 18/833,791

(22) PCT Filed: Jan. 27, 2023
(86) PCT No.: PCT/KR2023/001244

§ 371 Date: Jul. 26, 2024

(30) Foreign Application Priority Data
Jan. 28, 2022 (KR) 10-2022-0013605

(51) Int. Cl. G09G 3/20

(52) U.S. Cl. CPC G09G 3/2007; G09G 2320/0242; G09G 2320/0666; G09G 2330/028; G09G 2340/06

(57) ABSTRACT

A display apparatus for a dog includes a display panel including pixels, a dog filter which generates dog image data based on input image data and determine a second blue grayscale value of the dog image data by adding a first blue grayscale value of the input image data and a compensation value and a display panel driver which generates data voltages based on the dog image data and apply the data voltages to the pixels.

### TECHNICAL FIELD

The present inventive concept relates to a display apparatus for a dog. More particularly, the present inventive concept relates to a display apparatus for a dog displaying an image reflecting visual characteristics of dogs.

### BACKGROUND

Humans have cone cells which detect colors. Humans have three types of cone cells,

each of which is sensitive to different colors of light. For example, L-cones of humans are sensitive to light ranging between yellow and green, M-cones of humans are sensitive to light ranging between cyan and blue and S-cones of humans are sensitive to light ranging between blue and violet. Considering the above-mentioned visual characteristics of humans, a display apparatus has been developed to display various colors by mixing red, green and blue in appropriate proportions.

In contrast, dogs have two types of cone cells. Dogs may recognize red and green as yellow, and distinguish colors by combining only blue and yellow. In addition, unlike humans, dogs may easily distinguish colors as a wavelength of a color is closer to a wavelength of an ultraviolet ray. In other words, dogs have the highest color sensitivity to blue.

As mentioned above, the visual characteristics of dogs are different from the visual characteristics of humans so that the same image may be recognized differently by humans and animals (e.g. dogs).

### DETAILED EXPLANATION OF THE INVENTION

### Technical Purpose

The purpose of the present inventive concept is providing a display apparatus for a dog converting input image data to image data reflecting visual characteristics of dogs.

However, the technical purpose of the present inventive concept may not be limited to the above-mentioned purpose, and may be expanded in various ways without departing from the spirit and scope of the present inventive concept.

### Technical Solution

In an example display apparatus for a dog according to the present inventive concept to achieve the purpose of the present inventive concept, the display apparatus includes a display panel including pixels, a dog filter which generates dog image data based on input image data and determine a second blue grayscale value of the dog image data by adding a first blue grayscale value of the input image data and a compensation value and a display panel driver which generates data voltages based on the dog image data and applies the data voltages to the pixels.

In an embodiment, the display panel driver may activate the dog filter and generate the data voltages based on the dog image data in a dog mode. The display panel driver may deactivate the dog filter and generate the data voltages based on the input image data in a human mode.

In an embodiment, the dog filter may convert the input image data to dog recognition image data reflecting visual characteristics of dogs using a conversion table and determine the compensation value based on a difference between the dog recognition image data and the input image data.

In an embodiment, when a first red grayscale value of the input image data is greater than zero, the dog filter may determine the second blue grayscale value by adding the first blue grayscale value and the compensation value. When the first red grayscale value is zero, the dog filter may determine the first blue grayscale value as the second blue grayscale value.

In an embodiment, as the first red grayscale value increases, the compensation value may increase.

In an embodiment, when a first red grayscale value of the input image data is greater than the first blue grayscale value, the dog filter may determine the second blue grayscale value by adding the first blue grayscale value and the compensation value. When the first red grayscale value is equal to or less than the first blue grayscale value, the dog filter may determine the first blue grayscale value as the second blue grayscale value.

In an embodiment, as a difference between the first red grayscale value and the first blue grayscale value increases, the compensation value may increase.

In an embodiment, when a first red grayscale value of the input image data is greater than the first blue grayscale value and the first red grayscale value is greater than a first green grayscale value of the input image data, the dog filter may determine the second blue grayscale value by adding the first blue grayscale value and the compensation value. When the first red grayscale value is greater than the first blue grayscale value and the first red grayscale value is equal to or less than the first green grayscale value, the dog filter may determine the first blue grayscale value as the second blue grayscale value. When the first red grayscale value is equal to or less than the first blue grayscale value and the first red grayscale value is greater than the first green grayscale value, the dog filter may determine the first blue grayscale value as the second blue grayscale value. When the first red grayscale value is equal to or less than the first blue grayscale value and the first red grayscale value is equal to or less than the first green grayscale value, the dog filter may determine the first blue grayscale value as the second blue grayscale value.

In an embodiment, when a first red grayscale value of the input image data is greater than the first blue grayscale value and a first green grayscale value of the input image data is greater than the first blue grayscale value, the dog filter may determine the second blue grayscale value by adding the first blue grayscale value and the compensation value. When the first red grayscale value is greater than the first blue grayscale value and the first green grayscale value is equal to or less than the first blue grayscale value, the dog filter may determine the first blue grayscale value as the second blue grayscale value. When the first red grayscale value is equal to or less than the first blue grayscale value and the first green grayscale value is greater than the first blue grayscale value, the dog filter may determine the first blue grayscale value as the second blue grayscale value. When the first red grayscale value is equal to or less than the first blue grayscale value and the first green grayscale value is equal to or less than the first blue grayscale value, the dog filter may determine the first blue grayscale value as the second blue grayscale value.

In an embodiment, as a difference between the first red grayscale value and the first blue grayscale value increases, the compensation value may increase.

In an embodiment, as a difference between the first green grayscale value and the first blue grayscale value increases, the compensation value may increase.

In an embodiment, as a sum of a difference between the first red grayscale value and the first blue grayscale value and a difference between the first green grayscale value and the first blue grayscale value increases, the compensation value may increase.

In an embodiment, when a first green grayscale value of the input image data is greater than zero, the dog filter may determine the second blue grayscale value by adding the first blue grayscale value and the compensation value. When the first green grayscale value is zero, the dog filter may determine the first blue grayscale value as the second blue grayscale value.

In an embodiment, when a first green grayscale value of the input image data is greater than the first blue grayscale value, the dog filter may determine the second blue grayscale value by adding the first blue grayscale value and the compensation value. When the first green grayscale value is equal to or less than the first blue grayscale value, the dog filter may determine the first blue grayscale value as the second blue grayscale value.

In an embodiment, when a first green grayscale value of the input image data is greater than the first blue grayscale value and the first green grayscale value is greater than a first red grayscale value of the input image data, the dog filter may determine the second blue grayscale value by adding the first blue grayscale value and the compensation value. When the first green grayscale value is greater than the first blue grayscale value and the first green grayscale value is equal to or less than the first red grayscale value, the dog filter may determine the first blue grayscale value as the second blue grayscale value. When the first green grayscale value is equal to or less than the first blue grayscale value and the first green grayscale value is greater than the first red grayscale value, the dog filter may determine the first blue grayscale value as the second blue grayscale value. When the first green grayscale value is equal to or less than the first blue grayscale value and the first green grayscale value is equal to or less than the first red grayscale value, the dog filter may determine the first blue grayscale value as the second blue grayscale value.

In an embodiment, the dog filter may generate a third red grayscale value by converting a first red grayscale value of an RGB domain of the input image data into a sensitivity domain reflecting visual characteristics of dogs. The dog filter may generate a third blue grayscale value by converting the first blue grayscale value B of the RGB domain into the sensitivity domain. The dog filter may generate a third green grayscale value by converting a first green grayscale value of the RGB domain of the input image data into the sensitivity domain.

In an embodiment, when the third red grayscale value is greater than the third blue grayscale value, the dog filter may determine the second blue grayscale value by adding the first blue grayscale value and the compensation value. When the third red grayscale value is equal to or less than the third blue grayscale value, the dog filter may determine the first blue grayscale value as the second blue grayscale value.

In an embodiment, when the third red grayscale value is greater than the third blue grayscale value and the third red grayscale value is greater than the third green grayscale value, the dog filter may determine the second blue grayscale value by adding the first blue grayscale value and the compensation value. When the third red grayscale value is greater than the third blue grayscale value and the third red grayscale value is equal to or less than the third green grayscale value, the dog filter may determine the first blue grayscale value as the second blue grayscale value. When the third red grayscale value is equal to or less than the third blue grayscale value and the third red grayscale value is greater than the third green grayscale value, the dog filter may determine the first blue grayscale value as the second blue grayscale value. When the third red grayscale value is equal to or less than the third blue grayscale value and the third red grayscale value is equal to or less than the third green grayscale value, the dog filter may determine the first blue grayscale value as the second blue grayscale value.

In an embodiment, when the third red grayscale value is greater than the third blue grayscale value and the third green grayscale value is greater than the third blue grayscale value, the dog filter may determine the second blue grayscale value by adding the first blue grayscale value and the compensation value. When the third red grayscale value is greater than the third blue grayscale value and the third green grayscale value is equal to or less than the third blue grayscale value, the dog filter may determine the first blue grayscale value as the second blue grayscale value. When the third red grayscale value is equal to or less than the third blue grayscale value and the third green grayscale value is greater than the third blue grayscale value, the dog filter may determine the first blue grayscale value as the second blue grayscale value. When the third red grayscale value is equal to or less than the third blue grayscale value and the third green grayscale value is equal to or less than the third blue grayscale value, the dog filter may determine the first blue grayscale value as the second blue grayscale value.

In an embodiment, when the third green grayscale value is greater than the third blue grayscale value, the dog filter may determine the second blue grayscale value by adding the first blue grayscale value and the compensation value. When the third green grayscale value is equal to or less than the third blue grayscale value, the dog filter may determine the first blue grayscale value as the second blue grayscale value.

In an embodiment, when the third green grayscale value is greater than the third blue grayscale value and the third green grayscale value is greater than the third red grayscale value, the dog filter may determine the second blue grayscale value by adding the first blue grayscale value and the compensation value. When the third green grayscale value is greater than the third blue grayscale value and the third green grayscale value is equal to or less than the third red grayscale value, the dog filter may determine the first blue grayscale value as the second blue grayscale value. When the third green grayscale value is equal to or less than the third blue grayscale value and the third green grayscale value is greater than the third red grayscale value, the dog filter may determine the first blue grayscale value as the second blue grayscale value. When the third green grayscale value is equal to or less than the third blue grayscale value and the third green grayscale value is equal to or less than the third red grayscale value, the dog filter may determine the first blue grayscale value as the second blue grayscale value.

In an example display apparatus for a dog according to the present inventive concept to achieve the purpose of the present inventive concept, the display apparatus includes a display panel including pixels, a dog filter which generates dog image data based on input image data and determine a second red grayscale value of the dog image data by subtracting a compensation value from a first red grayscale value of the input image data and a display panel driver which generates data voltages based on the dog image data and applies the data voltages to the pixels.

In an embodiment, when the first red grayscale value is greater than zero, the dog filter may determine the second red grayscale value by subtracting the compensation value from the first red grayscale value.

In an embodiment, when the first red grayscale value is greater than a first blue grayscale value of the input image data, the dog filter may determine the second red grayscale value by subtracting the compensation value from the first red grayscale value. When the first red grayscale value is equal to or less than the first blue grayscale value, the dog filter may determine the first red grayscale value as the second red grayscale value.

In an embodiment, when the first red grayscale value is greater than a first blue grayscale value of the input image data and the first red grayscale value is greater than a first green grayscale value of the input image data, the dog filter may determine the second red grayscale value by subtracting the compensation value from the first red grayscale value. When the first red grayscale value is greater than the first blue grayscale value and the first red grayscale value is equal to or less than the first green grayscale value, the dog filter may determine the first red grayscale value as the second red grayscale value. When the first red grayscale value is equal to or less than the first blue grayscale value and the first red grayscale value is greater than the first green grayscale value, the dog filter may determine the first red grayscale value as the second red grayscale value. When the first red grayscale value is equal to or less than the first blue grayscale value and the first red grayscale value is equal to or less than the first green grayscale value, the dog filter may determine the first red grayscale value as the second red grayscale value.

In an embodiment, when the first red grayscale value is greater than a first blue grayscale value of the input image data and a first green grayscale value of the input image data is greater than the first blue grayscale value, the dog filter may determine the second red grayscale value by subtracting the compensation value from the first red grayscale value. When the first red grayscale value is greater than the first blue grayscale value and the first green grayscale value is equal to or less than the first blue grayscale value, the dog filter may determine the first red grayscale value as the second red grayscale value. When the first red grayscale value is equal to or less than the first blue grayscale value and the first green grayscale value is greater than the first blue grayscale value, the dog filter may determine the first red grayscale value as the second red grayscale value. When the first red grayscale value is equal to or less than the first blue grayscale value and the first green grayscale value is equal to or less than the first blue grayscale value, the dog filter may determine the first red grayscale value as the second red grayscale value.

In an example display apparatus for a dog according to the present inventive concept to achieve the purpose of the present inventive concept, the display apparatus includes a display panel including pixels, a dog filter which generates dog image data based on input image data and determine a second green grayscale value of the dog image data by subtracting a compensation value from a first green grayscale value of the input image data and a display panel driver which generates data voltages based on the dog image data and applies the data voltages to the pixels.

In an example display apparatus for a dog according to the present inventive concept to achieve the purpose of the present inventive concept, the display apparatus includes a display panel including pixels, a dog filter which generates dog image data by increasing a blue ratio of input image data and a display panel driver which generates data voltages based on the dog image data and applies the data voltages to the pixels.

In an embodiment, the dog filter may convert the input image data in an RGB domain to input image data in an HSV domain, generate a dog image data in the HSV domain by expanding a blue range of a color value of the input image data in the HSV domain and reducing a red range of the color value of the input image data in the HSV domain, and generate the dog image data in the RGB domain based on the dog image data in the HSV domain.

In an example display apparatus for a dog according to the present inventive concept to achieve the purpose of the present inventive concept, the display apparatus includes a display panel including pixels, a dog filter which generates dog image data by increasing a difference between a luminance of a red range of input image data and a luminance of a green range of the input image data and a display panel driver which generates data voltages based on the dog image data and applies the data voltages to the pixels.

### Effect of the Invention

The display apparatus for a dog according to the embodiments of the present inventive concept may generate the dog image data based on the input image data and include the dog filter determining the second blue grayscale value of the dog image data by adding the first blue grayscale value of the input image data and the compensation value so that the blue ratio of the displayed image may be increased.

The display apparatus for a dog according to the embodiments of the present inventive concept may generate the dog image data based on the input image data and include the dog filter determining the second red grayscale value of the dog image data by subtracting the compensation value from the first red grayscale value of the input image data so that the red ratio of the displayed image may be decreased.

The display apparatus for a dog according to the embodiments of the present inventive concept may generate the dog image data based on the input image data and include the dog filter determining the second green grayscale value of the dog image data by subtracting the compensation value from the first green grayscale value of the input image data so that the green ratio of the displayed image may be decreased.

The display apparatus for a dog according to the embodiments of the present inventive concept may increase the blue ratio, decrease the red ratio or decrease the green ratio so that the blue ratio which dogs can distinguish relatively well may be increased and the yellow ratio (the red ratio or the green ratio) which dogs cannot distinguish relatively well may be decreased. Accordingly, the input image data may be converted to the image data reflecting the visual characteristics of dogs.

The display apparatus for a dog according to the embodiments of the present inventive concept may increase a difference between a luminance of a red portion of the input image data and a luminance of a green portion of the input image data so that the red image and the green image may be distinguished well by the luminance difference. Accordingly, a dog, which cannot distinguish between red and green well, may distinguish between red and green images.

However, the effect of the present inventive concept may not be limited to the above-mentioned effect, and may be expanded in various ways without departing from the spirit and scope of the present inventive concept.

### BRIEF EXPLANATION OF THE DRAWINGS

FIG. 1a is a diagram illustrating an example of a use of a display apparatus for a dog.

FIG. 1b is a block diagram illustrating the display apparatus for a dog according to embodiments of the present inventive concept.

FIG. 2 is a graph illustrating color coordinates of a human and color coordinates of a dog.

FIG. 3a is a conceptual diagram illustrating an example of a dog filter of the display apparatus for a dog of FIG. 1b.

FIG. 3b is a diagram illustrating an example of a color change according to the dog filter of FIG. 3a.

FIG. 4 is a conceptual diagram illustrating a dog filter of a display apparatus for a dog according to embodiments of the present inventive concept.

FIG. 5a is a conceptual diagram illustrating a dog filter of a display apparatus for a dog according to embodiments of the present inventive concept.

FIG. 5b is a diagram illustrating an example of a color change according to the dog filter of FIG. 5a.

FIG. 6a is a conceptual diagram illustrating a dog filter of a display apparatus for a dog according to embodiments of the present inventive concept.

FIG. 6b is a diagram illustrating an example of a color change according to the dog filter of FIG. 6a.

FIG. 7a is a conceptual diagram illustrating a dog filter of a display apparatus for a dog according to embodiments of the present inventive concept.

FIG. 7b is a diagram illustrating an example of a color change according to the dog filter of FIG. 7a.

FIG. 8a is a conceptual diagram illustrating a dog filter of a display apparatus for a dog

according to embodiments of the present inventive concept.

FIG. 8b is a diagram illustrating an example of a color change according to the dog filter of FIG. 8a.

FIG. 9a is a conceptual diagram illustrating a dog filter of a display apparatus for a dog according to embodiments of the present inventive concept.

FIG. 9b is a diagram illustrating an example of a color change according to the dog filter of FIG. 9a.

FIG. 10a is a conceptual diagram illustrating a dog filter of a display apparatus for a dog according to embodiments of the present inventive concept.

FIG. 10b is a diagram illustrating an example of a color change according to the dog filter of FIG. 10a.

FIG. 11 is a graph illustrating a sensitivity of a human and a sensitivity of a dog and

FIG. 12 is a conceptual diagram illustrating a dog filter of a display apparatus for a dog according to embodiments of the present inventive concept.

FIG. 13 is a conceptual diagram illustrating a dog filter of a display apparatus for a dog according to embodiments of the present inventive concept.

FIG. 14 is a conceptual diagram illustrating a dog filter of a display apparatus for a dog according to embodiments of the present inventive concept.

FIG. 15 is a conceptual diagram illustrating a dog filter of a display apparatus for a dog according to embodiments of the present inventive concept.

FIG. 16 is a conceptual diagram illustrating a dog filter of a display apparatus for a dog according to embodiments of the present inventive concept.

FIG. 17 is a conceptual diagram illustrating a dog filter of a display apparatus for a dog according to embodiments of the present inventive concept.

FIG. 18 is a conceptual diagram illustrating a dog filter of a display apparatus for a dog according to embodiments of the present inventive concept.

FIGS. 19a, 20a, 21a and 22 to 26 are conceptual diagrams illustrating dog filters of display apparatuses for a dog according to embodiments of the present inventive concept.

FIG. 19b is a diagram illustrating an example of a color change according to the dog filter of FIG. 19a.

FIG. 20b is a diagram illustrating an example of a color change according to the dog filter of FIG. 20a.

FIG. 21b is a diagram illustrating an example of a color change according to the dog filter of FIG. 21a.

FIG. 27 is a diagram illustrating color coordinates of the display apparatuses for a dog of FIGS. 19a to 26.

FIGS. 28a, 29a and 30a are conceptual diagrams illustrating dog filters of display apparatuses for a dog according to embodiments of the present inventive concept.

FIG. 28b is a diagram illustrating an example of a color change according to the dog filter of FIG. 28a.

FIG. 29b is a diagram illustrating an example of a color change according to the dog filter of FIG. 29a.

FIG. 30b is a diagram illustrating an example of a color change according to the dog filter of FIG. 30a.

FIG. 31 is a conceptual diagram illustrating a dog filter of a display apparatus for a dog according to embodiments of the present inventive concept.

FIGS. 32 to 34 are conceptual diagrams illustrating dog filters of display apparatuses for a dog according to embodiments of the present inventive concept.

FIG. 35 is a conceptual diagram illustrating a dog filter of a display apparatus for a dog according to embodiments of the present inventive concept.

FIG. 36 is a diagram illustrating color coordinates of the display apparatuses for a dog of FIGS. 28a to 35.

FIG. 37 is a diagram illustrating color values of input image data and color values of dog image data of a display apparatus for a dog according to embodiments of the present inventive concept.

FIG. 38 is a diagram illustrating luminances for colors of a display apparatus for a dog according to embodiments of the present inventive concept.

### BEST MODE FOR CARRYING OUT THE INVENTION

Hereinafter, the present inventive concept will be explained in detail with reference to the accompanying drawings.

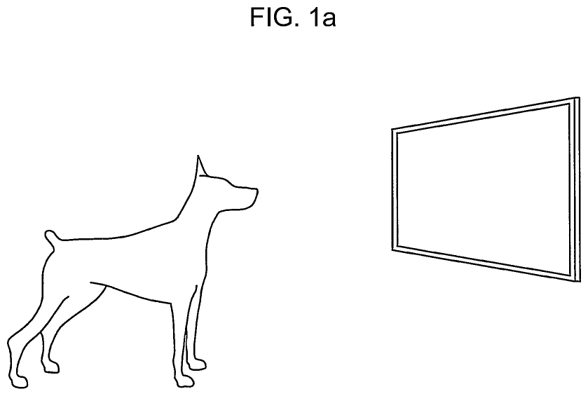

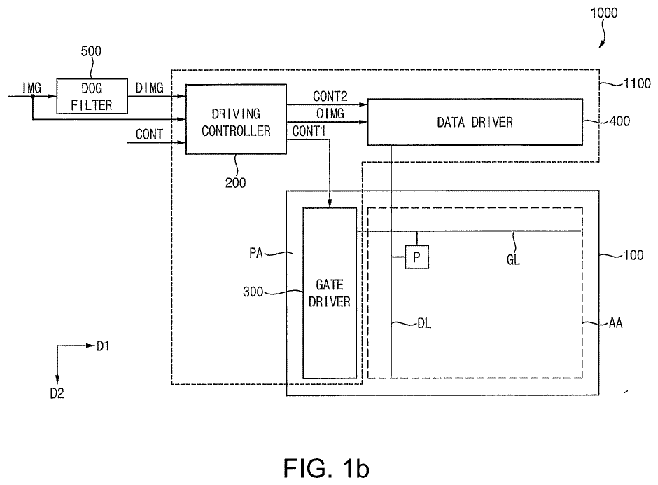

FIG. 1a is a diagram illustrating an example of a use of a display apparatus for a dog.

Referring to FIG. 1a, the display apparatus for a dog is installed at a position (or a height) where a dog can see, and may display images based on image data reflecting visual characteristics of a dog. The display apparatus displays the images based on the image data reflecting the visual characteristics of a dog so that a dog's concentration on the images may be enhanced. Hereinafter, the present inventive concept will be explained in detail.

FIG. 1b is a block diagram illustrating the display apparatus 1000 for a dog according to embodiments of the present inventive concept.

Referring to FIG. 1b, the display apparatus 1000 for a dog may include a display panel 100, a display panel driver 1100 and a dog filter 500. The display panel driver 1100 may include a driving controller 200, a gate driver 300 and a data driver 400. In an embodiment, the driving controller 200 and the data driver 400 may be integrated in a single chip. In an embodiment, the driving controller 200, the data driver 400 and the dog filter 500 may be integrated in a single chip.

In an embodiment, the dog filter 500 may include the driving controller 200. In another embodiment, the dog filter 500 may be integrated in a chip independently from the driving controller 200. In another embodiment, the dog filter 500 may be included in a host processor (e.g. a graphic processing unit (GPU) and so on).

The display panel 100 may include a display region AA and a peripheral region PA disposed adjacent to the display region AA. In an embodiment, the gate driver 300 may be mounted on the peripheral region PA.

The display panel 100 may include a plurality of gate lines GL, a plurality of data lines DL and a plurality of pixels P electrically connected to the gate lines GL and the data lines DL. The gate lines GL may extend in a first direction D1 and the data lines DL may extend in a second direction D2 crossing the first direction D1.

The driving controller 200 may receive input image data IMG and an input control signal CONT from the host processor. The driving controller 200 may receive dog image data DIMG from the dog filter. For example, the driving controller 200 may receive the dog image data DIMG in a dog mode and receive the input image data IMG in a human mode. For example, the display panel driver 1100 may generate data voltages based on the dog image data DIMG in the dog mode and generate data voltages based on the input image data IMG in the human mode. For example, the input image data IMG and the dog image data DIMG may include red image data, green image data and blue image data. In and embodiment, the input image data IMG and the dog image data DIMG may further include white image data. The input control signal CONT may include a master clock signal and a data enable signal. The input control signal CONT may further include a vertical synchronizing signal and a horizontal synchronizing signal.

Although the driving controller 200 receives the dog image data DIMG and the input image data IMG in FIG. 1b, the present inventive concept may not be limited thereto. For example, the driving controller 200 may not receive the input image data IMG but receive only the dog image data DIMG and the display apparatus 1000 for a dog does not have the dog mode and the human mode. In this case, the display apparatus 1000 for a dog may display an image based only on the dog image data DIMG. For example, when the driving controller 200 includes the dog filter 500, the driving controller 200 may not receive the dog image data DIMG but receive only the input image data IMG.

The driving controller 200 generates a first control signal CONT1, a second control signal CONT2 and output image data OIMG based on the input image data IMG, the dog image data DIMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 400 based on the input control signal CONT, and output the second control signal CONT2 to the data driver 400. The second control signal CONT2 may include a horizontal start signal and a load signal.

The driving controller 200 may generate the output image data OIMG based on the input image data IMG and the dog image data DIMG. The driving controller 200 may output the output image data OIMG to the data driver 400.

The gate driver 300 may generate gate signals driving the gate lines GL in response to the first control signal CONT1 received from the driving controller 200. The gate driver 300 may output the gate signals to the gate lines GL. For example, the gate driver 300 may sequentially output the gate signals to the gate lines GL.

The data driver 400 may receive the second control signal CONT2 and the d output image data OIMG from the driving controller 200. The data driver 400 may converts the data signal DATA into data voltages having an analog type using the gamma reference voltages VGREF. The data driver 500 outputs the data voltages to the data lines DL.

The dog filter 500 may generate the dog image data DIMG based on the input image data IMG. The dog image data DIMG may be the image data reflecting the visual characteristics of a dog. The dog filter 500 may convert the input image data IMG to the image data (the dog image data DIMG) reflecting the visual characteristics of a dog. Hereinafter, the present inventive concept will be explained in detail.

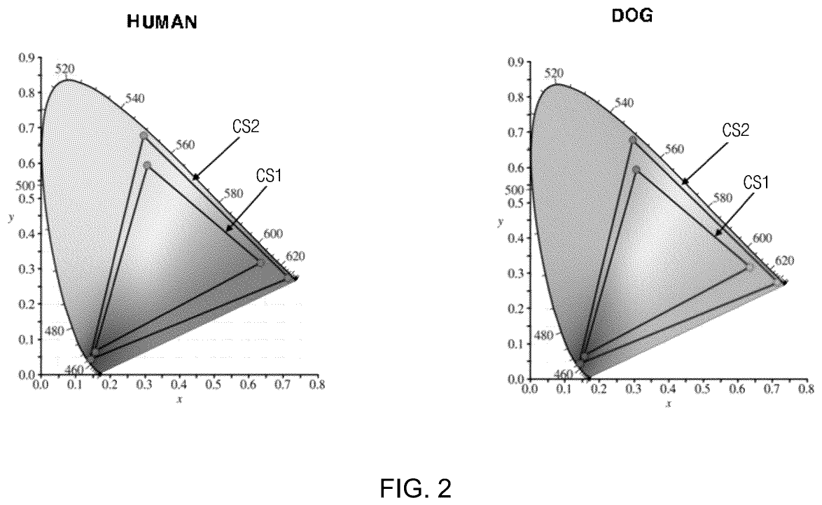

FIG. 2 is a graph illustrating color coordinates of a human and color coordinates of a dog, x axis of the color coordinates indicates a red ratio, y axis of the color coordinates indicates a green ratio and numbers (e.g. 460, 480, 500, 520, 540, 560, 580, 600 and 620) displayed in a color space indicate wavelengths in a unit of nm (The above descriptions are applied to all color coordinates in this disclosures below.)

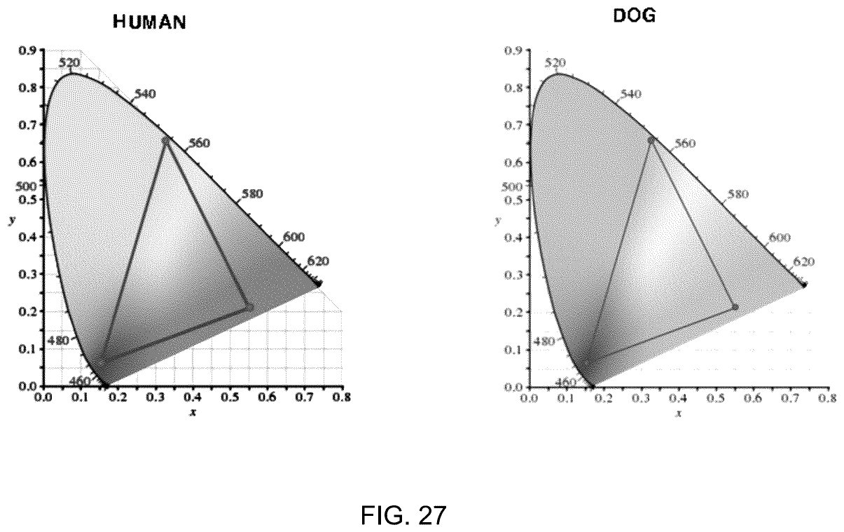

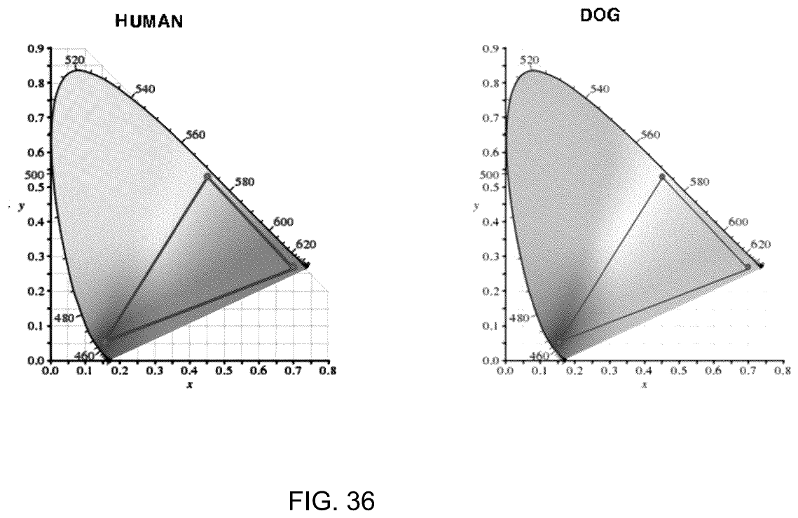

Referring to FIG. 2, dogs may recognize red and green as yellow, and distinguish colors by combining only blue and yellow. A color space of images of the display apparatus 1000 for a dog may be determined by a first color space CS1, a second color space CS2 and so on. FIGS. 27 and 36 will be explained based on the second color space CS2.

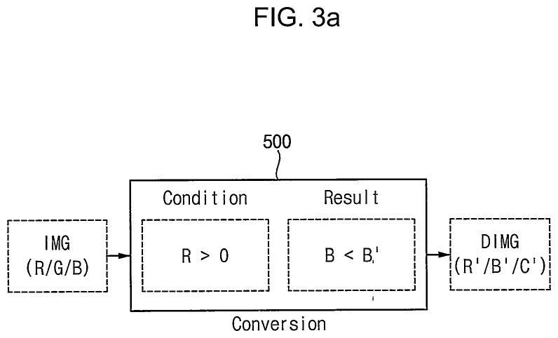

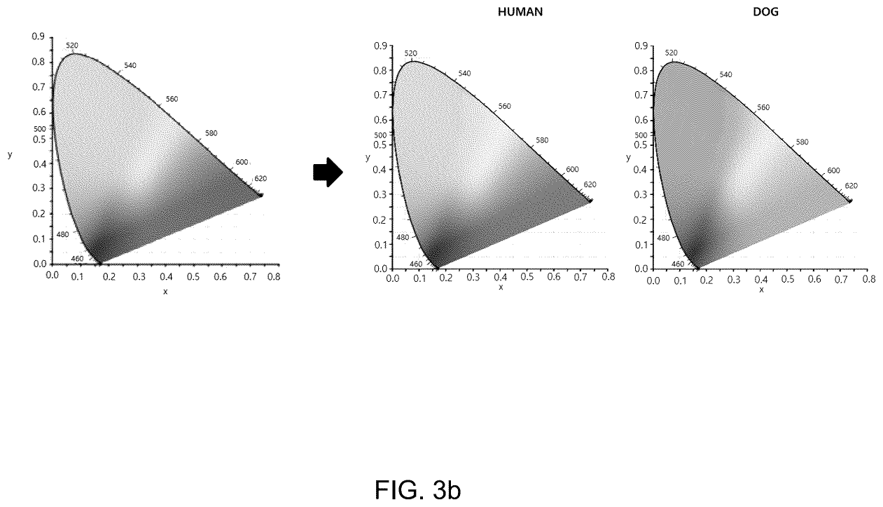

FIG. 3a is a conceptual diagram illustrating an example of the dog filter 500 of the display apparatus 1000 for a dog of FIG. 1b and FIG. 3b is a diagram illustrating an example of a color change according to the dog filter 500 of FIG. 3a. A left graph of FIG. 3b illustrates color coordinates of a human for the input image data IMG and two right graphs of FIG. 3b illustrate color coordinates of a human and color coordinates of a dog for the dog image data DIMG.

Referring to FIGS. 1b, 3a and 3b, the dog filter 500 may generate the dog image data DIMG based on the input image data IMG and determine a second blue grayscale value B′ of the dog image data DIMG by adding a first blue grayscale value B of the input image data IMG and a compensation value. When a first red grayscale value R of the input image data IMG is greater than zero, the dog filter 500 may determine the second blue grayscale value B′ of the dog image data DIMG by adding the first blue grayscale value B of the input image data IMG and the compensation value. When the first red grayscale value R is zero, the dog filter 500 may determine the first blue grayscale value B as the second blue grayscale value B′. As the first red grayscale value R increases, the compensation value may increase. For example, the compensation value may be greater than zero.

Each of the pixels may include a subpixel displaying a red image, a subpixel displaying a blue image and a subpixel displaying a green image. The display panel driver 1100 may generate data voltages applied to the subpixel displaying the red image based on the first red grayscale value R or the second red grayscale value R′, data voltages applied to the subpixel displaying the blue image based on the first blue grayscale value B or the second blue grayscale value B′ and data voltages applied to the subpixel displaying the green image based on a first green grayscale value G or a second green grayscale value G′. For example, the input image data IMG may include the first red grayscale value R between zero and 255, the first blue grayscale value B between zero and 255 and the first green grayscale value G between zero and 255 and the dog image data DIMG may include the second red grayscale value R′ between zero and 255, the second blue grayscale value B′ between zero and 255 and the second green grayscale value G′ between zero and 255. The values between zero and 255 may represent grayscale values.

As explained above, dogs may distinguish colors by combining only blue and yellow (Dogs may recognize red and green as yellow) and dogs may easily distinguish colors as a wavelength of a color is closer to a wavelength of an ultraviolet ray. Dogs may easily distinguish colors in a blue range. In other words, dogs may easily distinguish colors for an image having a high blue ratio. When the first red grayscale value R is greater than zero, the dog filter 500 may determine the second blue grayscale value B′ by adding the first blue grayscale value B and the compensation value. Thus, when the first red grayscale value R is greater than zero, the second blue grayscale value B′ may be greater than the first blue grayscale value B. The dog filter 500 may convert the input image data IMG to the dog image data DIMG having a high blue ratio.

As the first red grayscale value R increases, the compensation value may increase. As the first red grayscale value R increases, a blue ratio of the input image data IMG may decrease. Thus, as the first red grayscale value R increases, the compensation value may increase.

When the first red grayscale value R is zero, the dog filter 500 may determine the first blue grayscale value B as the second blue grayscale value B′. When the first red grayscale value R is zero, the blue ratio of the input image data IMG is already high so that the dog filter 500 may determine the first blue grayscale value B as the second blue grayscale value B′.

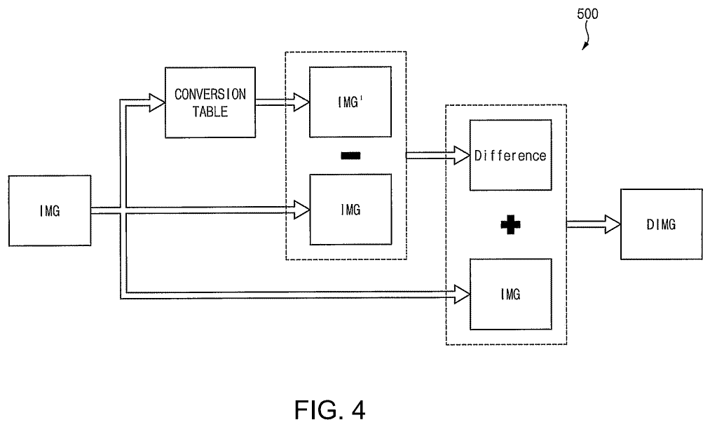

FIG. 4 is a conceptual diagram illustrating a dog filter 500 of the display apparatus for a dog according to embodiments of the present inventive concept.

The display apparatus for a dog according to the present embodiment is substantially the same as the display apparatus for a dog of FIG. 1b except for the dog filter 500. Thus, the same reference numerals will be used to refer to the same or like parts as those described in the previous embodiment and any repetitive explanation concerning the above elements will be omitted.

Referring to FIGS. 1b and 4, the dog filter 500 may convert the input image data IMG to dog recognition image data IMG' reflecting the visual characteristics of dogs using a conversion table and generate the dog image data DIMG by compensating the input image data IMG based on a difference between the dog recognition image data IMG' and the input image data IMG.

The dog filter 500 may generate the dog recognition image data IMG' by applying a predetermined weight to the input image data IMG using the conversion table. For example, the image displayed based on the dog recognition image data IMG' may include only blue and yellow. The dog filter 500 may convert the input image data IMG into image data which dogs actually recognize.

The dog filter 500 may generate the dog image data DIMG by compensating the input image data IMG based on the difference between the dog recognition image data IMG′ and the input image data IMG. For example, the dog filter 500 may compensate the input image data IMG by the difference. For example, the dog filter 500 may compensate the input image data IMG by a difference between a grayscale value of the dog recognition image data IMG' and a grayscale value of the input image data IMG.

The display apparatus for a dog may display the image which dogs actually recognize by compensating the input image data by a difference between data of the image which dogs actually recognize and the input image data.

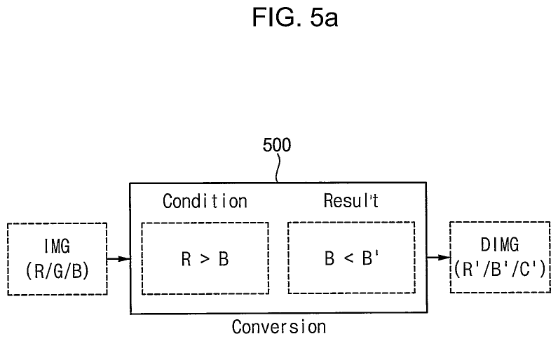

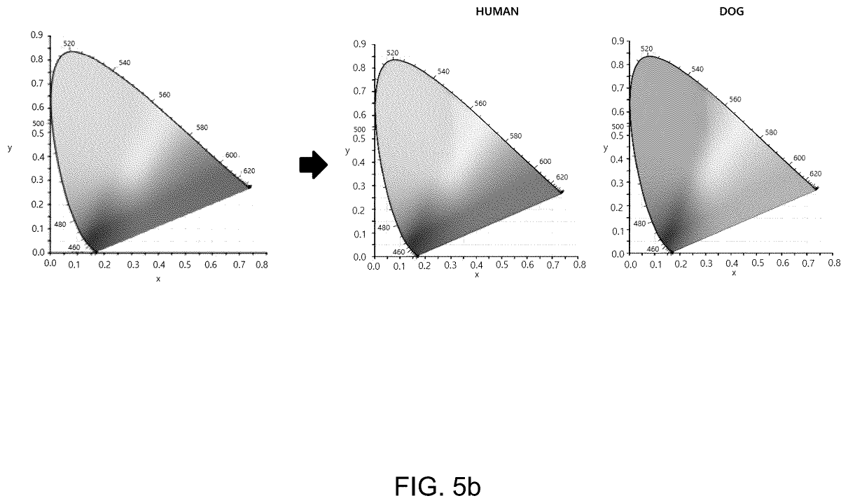

FIG. 5a is a conceptual diagram illustrating a dog filter 500 of a display apparatus for a dog according to embodiments of the present inventive concept and FIG. 5b is a diagram illustrating an example of a color change according to the dog filter 500 of FIG. 5a. A left graph of FIG. 5b illustrates color coordinates of a human for the input image data IMG and two right graphs of FIG. 5b illustrate color coordinates of a human and color coordinates of a dog for the dog image data DIMG.

The display apparatus for a dog according to the present embodiment is substantially the same as the display apparatus 1000 for a dog of FIG. 1b except for the method of generating the dog image data DIMG. Thus, the same reference numerals will be used to refer to the same or like parts as those described in the previous embodiment and any repetitive explanation concerning the above elements will be omitted.

Referring to FIGS. 1b, 5a and 5b, when the first red grayscale value R is greater than the first blue grayscale value B, the dog filter 500 may determine the second blue grayscale value B′ by adding the first blue grayscale value B and the compensation value. When the first red grayscale value R is equal to or less than the first blue grayscale value B, the dog filter 500 may determine the first blue grayscale value B as the second blue grayscale value B′. As a difference between the first red grayscale value R and the first blue grayscale value B increases, the compensation value may increase.

When the first red grayscale value R is greater than the first blue grayscale value B, the dog filter 500 may determine the second blue grayscale value B′ by adding the first blue grayscale value B and the compensation value. Thus, when the first red grayscale value R is greater than the first blue grayscale value B, the second blue grayscale value B′ may be greater than the first blue grayscale value B. The dog filter 500 may convert the input image data IMG to the dog image data DIMG having a high blue ratio.

As the difference between the first red grayscale value R and the first blue grayscale value B increases, the compensation value may increase. As the difference between the first red grayscale value R and the first blue grayscale value B increases, a blue ratio of the input image data IMG may decrease. Thus, as the difference between the first red grayscale value R and the first blue grayscale value B increases, the compensation value may increase.

When the first red grayscale value R is equal to or less than the first blue grayscale value B, the dog filter 500 may determine the first blue grayscale value B as the second blue grayscale value B′. When the first red grayscale value R is equal to or less than the first blue grayscale value B, the blue ratio of the input image data IMG is already high so that the dog filter 500 may determine the first blue grayscale value B as the second blue grayscale value B′.

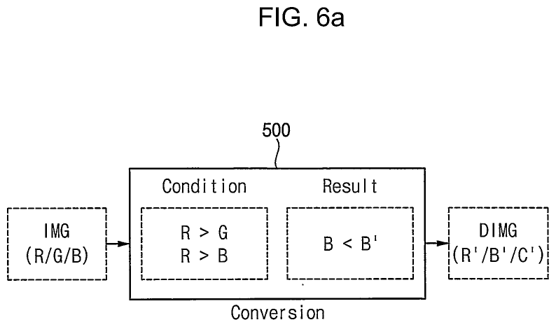

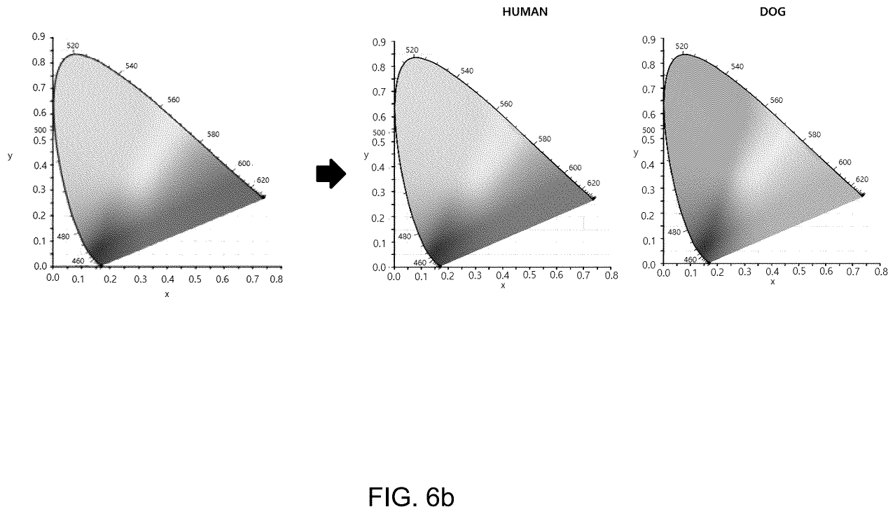

FIG. 6a is a conceptual diagram illustrating a dog filter 500 of a display apparatus for a dog according to embodiments of the present inventive concept and FIG. 6b is a diagram illustrating an example of a color change according to the dog filter 500 of FIG. 6a. A left graph of FIG. 6b illustrates color coordinates of a human for the input image data IMG and two right graphs of FIG. 6b illustrate color coordinates of a human and color coordinates of a dog for the dog image data DIMG.

The display apparatus for a dog according to the present embodiment is substantially the same as the display apparatus 1000 for a dog of FIG. 1b except for the method of generating the dog image data DIMG. Thus, the same reference numerals will be used to refer to the same or like parts as those described in the previous embodiment and any repetitive explanation concerning the above elements will be omitted.

Referring to FIGS. 1b, 6a and 6b, when the first red grayscale value R is greater than the first blue grayscale value B and the first red grayscale value R is greater than the first green grayscale value G of the green image data of the input image data, the dog filter 500 may determine the second blue grayscale value B′ by adding the first blue grayscale value B and the compensation value. When the first red grayscale value R is greater than the first blue grayscale value B and the first red grayscale value R is equal to or less than the first green grayscale value G, the dog filter 500 may determine the first blue grayscale value B as the second blue grayscale value B′. When the first red grayscale value R is equal to or less than the first blue grayscale value B and the first red grayscale value R is greater than the first green grayscale value G, the dog filter 500 may determine the first blue grayscale value B as the second blue grayscale value B′. When the first red grayscale value R is equal to or less than the first blue grayscale value B and the first red grayscale value R is equal to or less than the first green grayscale value G, the dog filter 500 may determine the first blue grayscale value B as the second blue grayscale value B′. As a difference between the first red grayscale value R and the first blue grayscale value B increases, the compensation value may increase.

When the first red grayscale value R is greater than the first blue grayscale value B and the first red grayscale value R is greater than the first green grayscale value G, the dog filter 500 may determine the second blue grayscale value B′ by adding the first blue grayscale value B and the compensation value. Thus, when the first red grayscale value R is greater than the first blue grayscale value B and the first red grayscale value R is greater than the first green grayscale value G, the second blue grayscale value B′ may be greater than the first blue grayscale value B. The dog filter 500 may convert the input image data IMG to the dog image data DIMG having a high blue ratio.

As the difference between the first red grayscale value R and the first blue grayscale value B increases, the compensation value may increase. As the difference between the first red grayscale value R and the first blue grayscale value B increases, a blue ratio of the input image data IMG may decrease. Thus, as the difference between the first red grayscale value R and the first blue grayscale value B increases, the compensation value may increase.

When the first red grayscale value R is greater than the first blue grayscale value B and the first red grayscale value R is equal to or less than the first green grayscale value G, the dog filter 500 may determine the first blue grayscale value B as the second blue grayscale value B′. When the first red grayscale value R is equal to or less than the first blue grayscale value B and the first red grayscale value R is greater than the first green grayscale value G, the dog filter 500 may determine the first blue grayscale value B as the second blue grayscale value B′. When the first red grayscale value R is equal to or less than the first blue grayscale value B and the first red grayscale value R is equal to or less than the first green grayscale value G, the dog filter 500 may determine the first blue grayscale value B as the second blue grayscale value B′. When the first red grayscale value R is equal to or less than the first blue grayscale value B, the blue ratio of the input image data IMG is already high so that the dog filter 500 may determine the first blue grayscale value B as the second blue grayscale value B′.

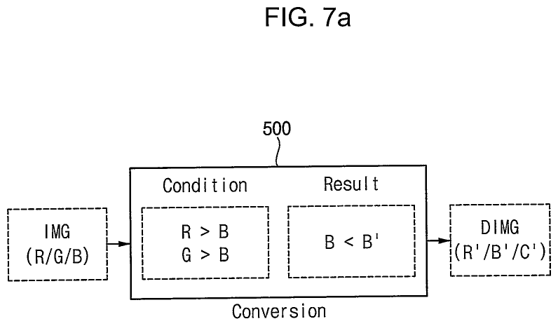

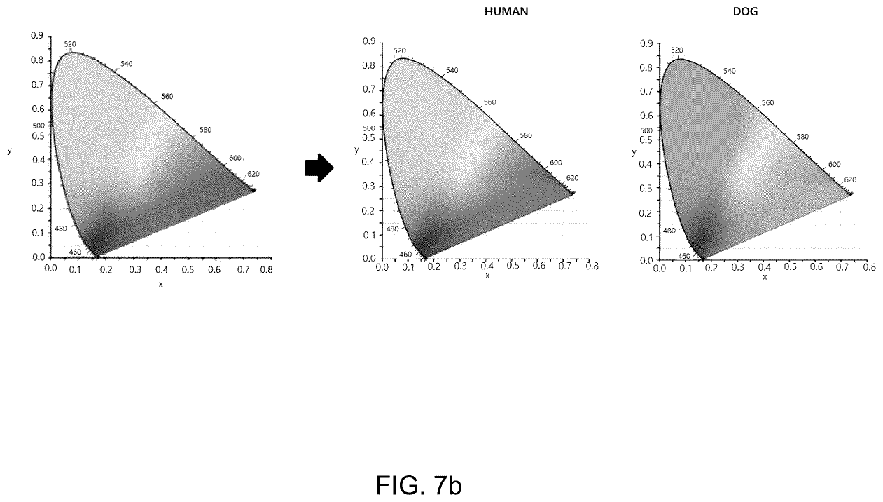

FIG. 7a is a conceptual diagram illustrating a dog filter 500 of a display apparatus for a dog according to embodiments of the present inventive concept and FIG. 7b is a diagram illustrating an example of a color change according to the dog filter 500 of FIG. 7a. A left graph of FIG. 7b illustrates color coordinates of a human for the input image data IMG and two right graphs of FIG. 7b illustrate color coordinates of a human and color coordinates of a dog for the dog image data DIMG.

The display apparatus for a dog according to the present embodiment is substantially the same as the display apparatus 1000 for a dog of FIG. 1b except for the method of generating the dog image data DIMG. Thus, the same reference numerals will be used to refer to the same or like parts as those described in the previous embodiment and any repetitive explanation concerning the above elements will be omitted.

Referring to FIGS. 1b, 7a and 7b, when the first red grayscale value R is greater than the first blue grayscale value B and the first green grayscale value G is greater than the first blue grayscale value B, the dog filter 500 may determine the second blue grayscale value B′ by adding the first blue grayscale value B and the compensation value. When the first red grayscale value R is greater than the first blue grayscale value B and the first green grayscale value G is equal to or less than the first blue grayscale value B of the green image data of the input image data, the dog filter 500 may determine the first blue grayscale value B as the second blue grayscale value B′. When the first red grayscale value R is equal to or less than the first blue grayscale value B and the first green grayscale value G is greater than the first blue grayscale value B, the dog filter 500 may determine the first blue grayscale value B as the second blue grayscale value B′. When the first red grayscale value R is equal to or less than the first blue grayscale value B and the first green grayscale value G is equal to or less than the first blue grayscale value B, the dog filter 500 may determine the first blue grayscale value B as the second blue grayscale value B′. As a difference between the first red grayscale value R and the first blue grayscale value B increases, the compensation value may increase.

When the first red grayscale value R is greater than the first blue grayscale value B and the first green grayscale value G is greater than the first blue grayscale value B, the dog filter 500 may determine the second blue grayscale value B′ by adding the first blue grayscale value B and the compensation value. Thus, when the first red grayscale value R is greater than the first blue grayscale value B and the first green grayscale value G is greater than the first blue grayscale value B, the second blue grayscale value B′ may be greater than the first blue grayscale value B. The dog filter 500 may convert the input image data IMG to the dog image data DIMG having a high blue ratio.

In an embodiment, as the difference between the first red grayscale value R and the first blue grayscale value B increases, the compensation value may increase. As the difference between the first red grayscale value R and the first blue grayscale value B increases, a blue ratio of the input image data IMG may decrease. Thus, as the difference between the first red grayscale value R and the first blue grayscale value B increases, the compensation value may increase.

In an embodiment, as the difference between the first green grayscale value G and the first blue grayscale value B increases, the compensation value may increase. As the difference between the first green grayscale value G and the first blue grayscale value B increases, a blue ratio of the input image data IMG may decrease. Thus, as the difference between the first green grayscale value G and the first blue grayscale value B increases, the compensation value may increase.

In an embodiment, as a sum of the difference between the first red grayscale value R and the first blue grayscale value B and the difference between the first green grayscale value G and the first blue grayscale value B increases, the compensation value may increase. As the sum of the difference between the first red grayscale value R and the first blue grayscale value B and the difference between the first green grayscale value G and the first blue grayscale value B increases, a blue ratio of the input image data IMG may decrease. Thus, as the sum of the difference between the first red grayscale value R and the first blue grayscale value B and the difference between the first green grayscale value G and the first blue grayscale value B increases, the compensation value may increase.

When the first red grayscale value R is greater than the first blue grayscale value B and the first green grayscale value G is equal to or less than the first blue grayscale value B of the green image data of the input image data, the dog filter 500 may determine the first blue grayscale value B as the second blue grayscale value B′. When the first red grayscale value R is equal to or less than the first blue grayscale value B and the first green grayscale value G is greater than the first blue grayscale value B, the dog filter 500 may determine the first blue grayscale value B as the second blue grayscale value B′. When the first red grayscale value R is equal to or less than the first blue grayscale value B and the first green grayscale value G is equal to or less than the first blue grayscale value B, the dog filter 500 may determine the first blue grayscale value B as the second blue grayscale value B′. Dogs may recognize red and green as yellow and recognize blue as blue so that the blue ratio of the input image data IMG is already high when the one of the first red grayscale value R and the first green grayscale value G is equal to or less than the first blue grayscale value B. Thus, when the one of the first red grayscale value R and the first green grayscale value G is equal to or less than the first blue grayscale value B, the dog filter 500 may determine the first blue grayscale value B as the second blue grayscale value B′.

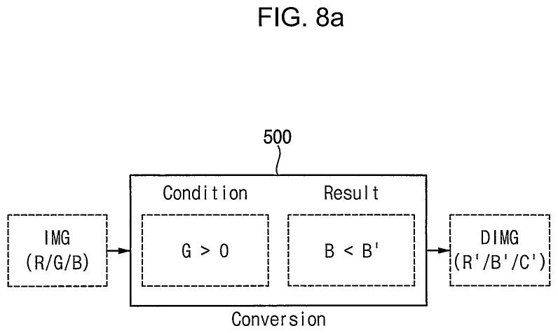

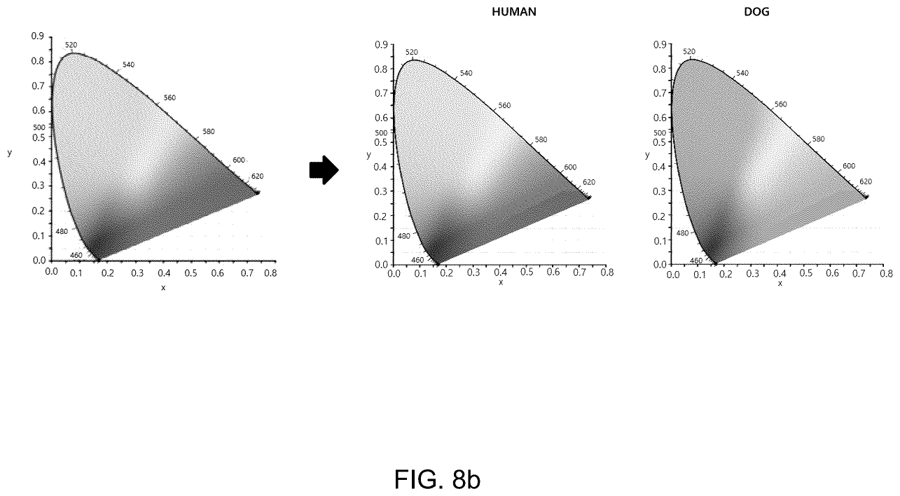

FIG. 8a is a conceptual diagram illustrating a dog filter 500 of a display apparatus for a dog according to embodiments of the present inventive concept and FIG. 8b is a diagram illustrating an example of a color change according to the dog filter 500 of FIG. 8a. A left graph of FIG. 8b illustrates color coordinates of a human for the input image data IMG and two right graphs of FIG. 8b illustrate color coordinates of a human and color coordinates of a dog for the dog image data DIMG.

The display apparatus for a dog according to the present embodiment is substantially the same as the display apparatus 1000 for a dog of FIG. 1b except for the method of generating the dog image data DIMG. Thus, the same reference numerals will be used to refer to the same or like parts as those described in the previous embodiment and any repetitive explanation concerning the above elements will be omitted.

Referring to FIGS. 1b, 8a and 8b, when a first green grayscale value G is greater than zero, the dog filter 500 may determine the second blue grayscale value B′ of the dog image data DIMG by adding the first blue grayscale value B of the input image data IMG and the compensation value. When the first green grayscale value G is zero, the dog filter 500 may determine the first blue grayscale value B as the second blue grayscale value B′. As the first green grayscale value G increases, the compensation value may increase. For example, the compensation value may be greater than zero.

When the first green grayscale value G is greater than zero, the dog filter 500 may determine the second blue grayscale value B′ by adding the first blue grayscale value B and the compensation value. Thus, when first green grayscale value G is greater than zero, the second blue grayscale value B′ may be greater than the first blue grayscale value B. The dog filter 500 may convert the input image data IMG to the dog image data DIMG having a high blue ratio.

As the first green grayscale value G increases, the compensation value may increase. As the first green grayscale value G increases, a blue ratio of the input image data IMG may decrease. Thus, as the first green grayscale value G increases, the compensation value may increase.

When the first green grayscale value G is zero, the dog filter 500 may determine the first blue grayscale value B as the second blue grayscale value B′. When the first green grayscale value G is zero, the blue ratio of the input image data IMG is already high so that the dog filter 500 may determine the first blue grayscale value B as the second blue grayscale value B′.

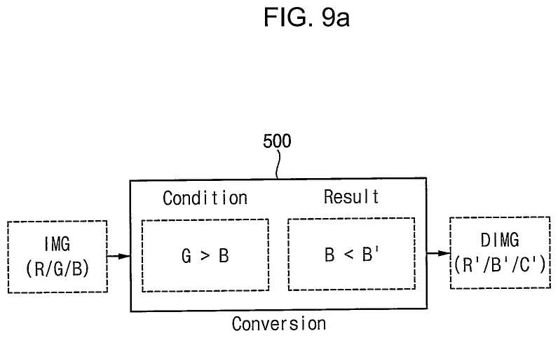

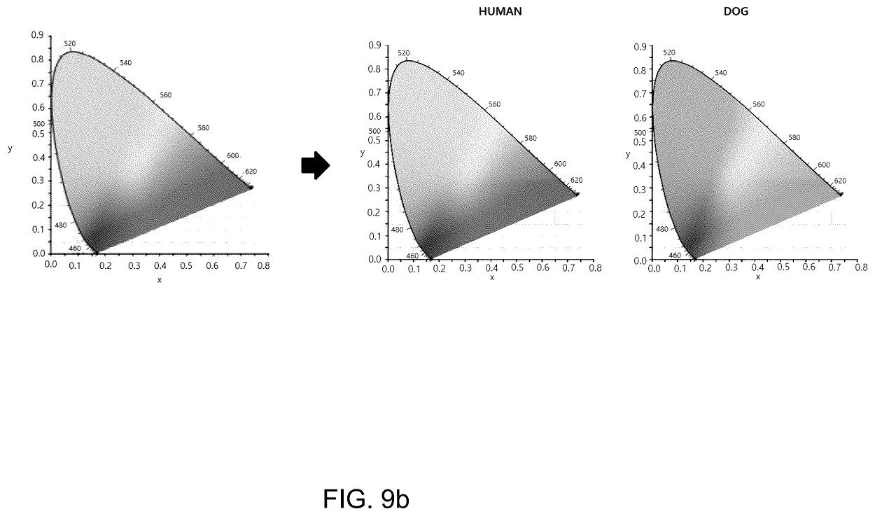

FIG. 9a is a conceptual diagram illustrating a dog filter 500 of a display apparatus for a dog according to embodiments of the present inventive concept and FIG. 9b is a diagram illustrating an example of a color change according to the dog filter 500 of FIG. 9a. A left graph of FIG. 9b illustrates color coordinates of a human for the input image data IMG and two right graphs of FIG. 9b illustrate color coordinates of a human and color coordinates of a dog for the dog image data DIMG.

The display apparatus for a dog according to the present embodiment is substantially the same as the display apparatus for a dog of FIG. 8a except for the method of generating the dog image data DIMG. Thus, the same reference numerals will be used to refer to the same or like parts as those described in the previous embodiment and any repetitive explanation concerning the above elements will be omitted.

Referring to FIGS. 1b, 9a and 9b, when the first green grayscale value G is greater than the first blue grayscale value B, the dog filter 500 may determine the second blue grayscale value B′ by adding the first blue grayscale value B and the compensation value. When the first green grayscale value G is equal to or less than the first blue grayscale value B, the dog filter 500 may determine the first blue grayscale value B as the second blue grayscale value B′. As a difference between the first green grayscale value G and the first blue grayscale value B increases, the compensation value may increase.

When the first green grayscale value G is greater than the first blue grayscale value B, the dog filter 500 may determine the second blue grayscale value B′ by adding the first blue grayscale value B and the compensation value. Thus, when the first green grayscale value G is greater than the first blue grayscale value B, the second blue grayscale value B′ may be greater than the first blue grayscale value B. The dog filter 500 may convert the input image data IMG to the dog image data DIMG having a high blue ratio.

As the difference between the first green grayscale value G and the first blue grayscale value B increases, the compensation value may increase. As the difference between the first green grayscale value G and the first blue grayscale value B increases, a blue ratio of the input image data IMG may decrease. Thus, as the difference between the first green grayscale value G and the first blue grayscale value B increases, the compensation value may increase.

When the first green grayscale value G is equal to or less than the first blue grayscale value B, the dog filter 500 may determine the first blue grayscale value B as the second blue grayscale value B′. When the first green grayscale value G is equal to or less than the first blue grayscale value B, the blue ratio of the input image data IMG is already high so that the dog filter 500 may determine the first blue grayscale value B as the second blue grayscale value B′.

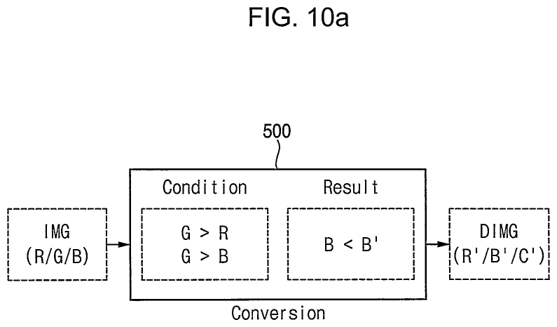

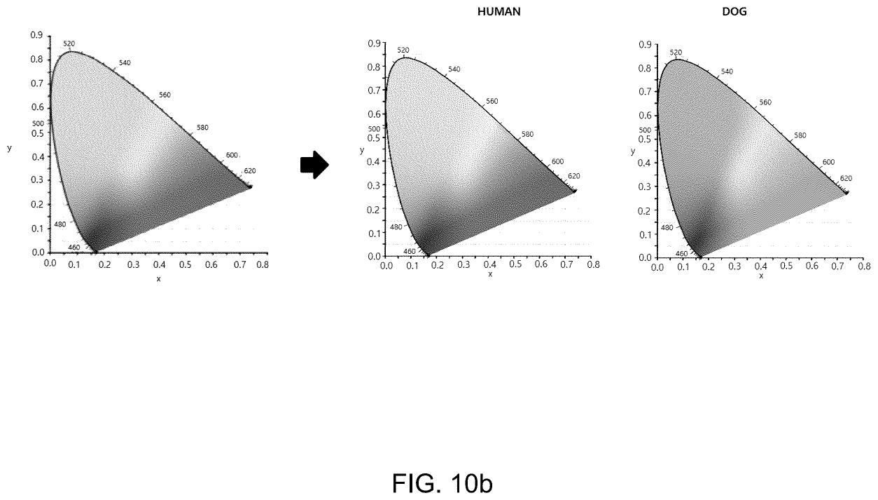

FIG. 10a is a conceptual diagram illustrating a dog filter 500 of a display apparatus for a dog according to embodiments of the present inventive concept and FIG. 10b is a diagram illustrating an example of a color change according to the dog filter 500 of FIG. 10a. A left graph of FIG. 10b illustrates color coordinates of a human for the input image data IMG and two right graphs of FIG. 10b illustrate color coordinates of a human and color coordinates of a dog for the dog image data DIMG.

The display apparatus for a dog according to the present embodiment is substantially the same as the display apparatus for a dog of FIG. 8a except for the method of generating the dog image data DIMG. Thus, the same reference numerals will be used to refer to the same or like parts as those described in the previous embodiment and any repetitive explanation concerning the above elements will be omitted.

Referring to FIGS. 1b, 10a and 10b, when the first green grayscale value G is greater than the first blue grayscale value B and the first green grayscale value G is greater than the first red grayscale value R, the dog filter 500 may determine the second blue grayscale value B′ by adding the first blue grayscale value B and the compensation value. When the first green grayscale value G is greater than the first blue grayscale value B and the first green grayscale value G is equal to or less than the first red grayscale value R, the dog filter 500 may determine the first blue grayscale value B as the second blue grayscale value B′. When the first green grayscale value G is equal to or less than the first blue grayscale value B and the first green grayscale value G is greater than the first red grayscale value R, the dog filter 500 may determine the first blue grayscale value B as the second blue grayscale value B′. When the first green grayscale value G is equal to or less than the first blue grayscale value B and the first green grayscale value G is equal to or less than the first red grayscale value R, the dog filter 500 may determine the first blue grayscale value B as the second blue grayscale value B′. As a difference between the first green grayscale value G and the first blue grayscale value B increases, the compensation value may increase.

When the first green grayscale value G is greater than the first blue grayscale value B and the first green grayscale value G is greater than the first red grayscale value R, the dog filter 500 may determine the second blue grayscale value B′ by adding the first blue grayscale value B and the compensation value. Thus, when the first green grayscale value G is greater than the first blue grayscale value B and the first green grayscale value G is greater than the first red grayscale value R, the second blue grayscale value B′ may be greater than the first blue grayscale value B. The dog filter 500 may convert the input image data IMG to the dog image data DIMG having a high blue ratio.

As the difference between the first green grayscale value G and the first blue grayscale value B increases, the compensation value may increase. As the difference between the first green grayscale value G and the first blue grayscale value B increases, a blue ratio of the input image data IMG may decrease. Thus, as the difference between the first green grayscale value G and the first blue grayscale value B increases, the compensation value may increase.

When the first green grayscale value G is greater than the first blue grayscale value B and the first green grayscale value G is equal to or less than the first red grayscale value R, the dog filter 500 may determine the first blue grayscale value B as the second blue grayscale value B′. When the first green grayscale value G is equal to or less than the first blue grayscale value B and the first green grayscale value G is greater than the first red grayscale value R, the dog filter 500 may determine the first blue grayscale value B as the second blue grayscale value B′. When the first green grayscale value G is equal to or less than the first blue grayscale value B and the first green grayscale value G is equal to or less than the first red grayscale value R, the dog filter 500 may determine the first blue grayscale value B as the second blue grayscale value B′. When the first green grayscale value G is equal to or less than the first blue grayscale value B, the blue ratio of the input image data IMG is already high so that the dog filter 500 may determine the first blue grayscale value B as the second blue grayscale value B′.

FIG. 11 is a graph illustrating a sensitivity of a human and a sensitivity of a dog and FIG. 12 is a conceptual diagram illustrating a dog filter of a display apparatus for a dog according to embodiments of the present inventive concept.

The display apparatus for a dog according to the present embodiment is substantially the same as the display apparatus 1000 for a dog of FIG. 1b except for the method of generating the dog image data DIMG. Thus, the same reference numerals will be used to refer to the same or like parts as those described in the previous embodiment and any repetitive explanation concerning the above elements will be omitted.

Referring to FIGS. 1b, 11 and 12, the dog filter 500 may generate a third red grayscale value R″ by converting the first red grayscale value R of an RGB domain into a sensitivity domain reflecting visual characteristics of dogs, generate a third blue grayscale value B″ by converting the first blue grayscale value B of the RGB domain into the sensitivity domain and generate a third green grayscale value G″ by converting the first green grayscale value G of the RGB domain into the sensitivity domain.

Red color sensitivity of humans is greater than blue color sensitivity of humans and green color sensitivity of humans is greater than the red color sensitivity of humans. Unlike humans, dogs easily distinguish colors as a wavelength of a color is closer to a wavelength of an ultraviolet ray. In other words, unlike humans, dogs have the highest color sensitivity to blue among red, green and blue. Thus, the dog filter 500 may convert the RGB domain into the sensitivity domain to reflect the above-explained visual characteristics of dogs well.

For example, the dog filter 500 may apply weights to the first red grayscale value R, the first green grayscale value G and the first blue grayscale value B to convert the RGB domain into the sensitivity domain. A first weight may be applied to the first red grayscale value R, a second weight may be applied to the first green grayscale value G and a third weight may be applied to the first blue grayscale value B. Dogs have the highest color sensitivity to blue among red, green and blue so that the third weight may be greater than the first weight and the second weight. For example, the third red grayscale value R″, the third blue grayscale value B″ and the third green grayscale value B″ may be calculated using following equations.

$$R 3 = S 1 * R 1 \\ G 3 = S 2 * G 1 \\ B 3 = S 3 * B 1 \\ S 3 > S 2 > S 1 \qquad [ Equations ]$$

Herein, R1 may be the first red grayscale value, G1 may be the first green grayscale value, B1 may be the first blue grayscale value, R3 may be the third red grayscale value, G3 may be the third green grayscale value, B3 may be the third blue grayscale value, S1 may be the first weight, S2 may be the second weight and S3 may be the third weight.

The dog filter 500 may generate the dog image data DIMG based on the input image data IMG and determine a second blue grayscale value B′ of blue image data of the dog image data DIMG by adding a first blue grayscale value B of blue image data of the input image data IMG and a compensation value. When the third red grayscale value R″ is greater than zero, the dog filter 500 may determine the second blue grayscale value B′ of the dog image data DIMG by adding the first blue grayscale value B of the input image data IMG and the compensation value. When the third red grayscale value R″ is zero, the dog filter 500 may determine the first blue grayscale value B as the second blue grayscale value B′. As the first red grayscale value R increases, the compensation value may increase. For example, the compensation value may be greater than zero.

When the third red grayscale value R″ is greater than zero, the dog filter 500 may determine the second blue grayscale value B′ by adding the first blue grayscale value B and the compensation value. Thus, when the third red grayscale value R″ is greater than zero, the second blue grayscale value B′ may be greater than the first blue grayscale value B. The dog filter 500 may convert the input image data IMG to the dog image data DIMG having a high blue ratio.

As the third red grayscale value R″ increases, the compensation value may increase. As the third red grayscale value R″ increases, a blue ratio of the input image data IMG may decrease. Thus, as the third red grayscale value R″ increases, the compensation value may increase.

When the third red grayscale value R″ is zero, the dog filter 500 may determine the first blue grayscale value B as the second blue grayscale value B′. When the third red grayscale value R″ is zero, the blue ratio of the input image data IMG is already high so that the dog filter 500 may determine the first blue grayscale value B as the second blue grayscale value B′.

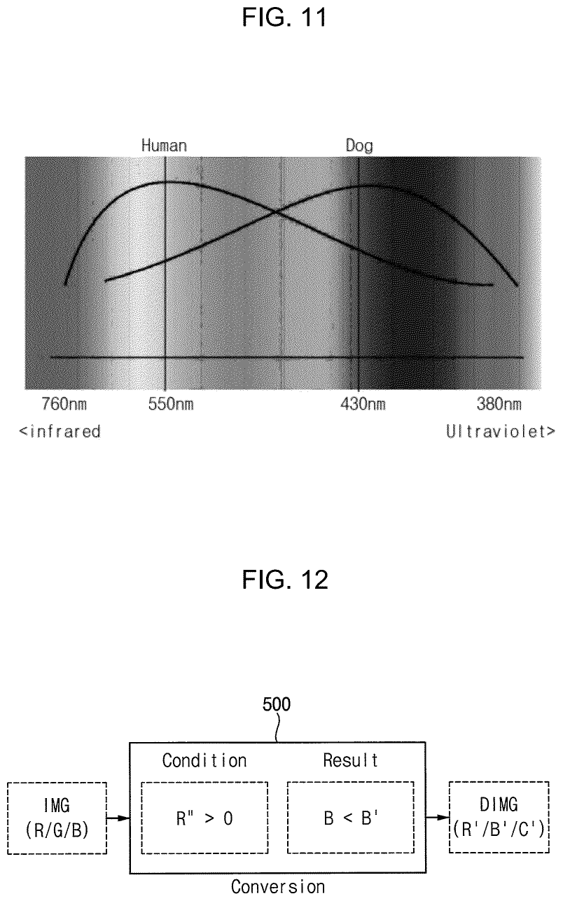

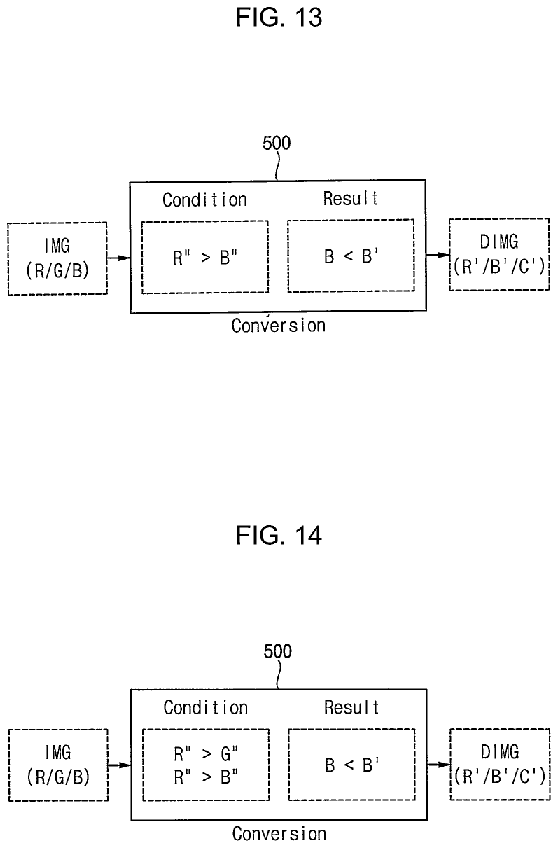

FIG. 13 is a conceptual diagram illustrating a dog filter of a display apparatus for a dog according to embodiments of the present inventive concept.

The display apparatus for a dog according to the present embodiment is substantially the same as the display apparatus for a dog of FIG. 12 except for the method of generating the dog image data DIMG. Thus, the same reference numerals will be used to refer to the same or like parts as those described in the previous embodiment and any repetitive explanation concerning the above elements will be omitted.

Referring to FIGS. 1b and 13, when the third red grayscale value R″ is greater than the third blue grayscale value B″, the dog filter 500 may determine the second blue grayscale value B′ by adding the first blue grayscale value B and the compensation value. When the third red grayscale value R″ is equal to or less than the third blue grayscale value B″, the dog filter 500 may determine the first blue grayscale value B as the second blue grayscale value B′. As a difference between the third red grayscale value R″ and the third blue grayscale value B″ increases, the compensation value may increase.

When the third red grayscale value R″ is greater than the third blue grayscale value B″, the dog filter 500 may determine the second blue grayscale value B′ by adding the first blue grayscale value B and the compensation value. Thus, when the third red grayscale value R″ is greater than the third blue grayscale value B″, the second blue grayscale value B′ may be greater than the first blue grayscale value B. The dog filter 500 may convert the input image data IMG to the dog image data DIMG having a high blue ratio.

As the difference between the third red grayscale value R″ and the third blue grayscale value B″ increases, the compensation value may increase. As the difference between the third red grayscale value R″ and the third blue grayscale value B″ increases, a blue ratio of the input image data IMG may decrease. Thus, as the difference between the third red grayscale value R″ and the third blue grayscale value B″ increases, the compensation value may increase.

When the third red grayscale value R″ is equal to or less than the third blue grayscale value B″, the dog filter 500 may determine the first blue grayscale value B as the second blue grayscale value B′. When the third red grayscale value R″ is equal to or less than the third blue grayscale value B″, the blue ratio of the input image data IMG is already high so that the dog filter 500 may determine the first blue grayscale value B as the second blue grayscale value B′.

FIG. 14 is a conceptual diagram illustrating a dog filter 500 of a display apparatus for a dog according to embodiments of the present inventive concept.

The display apparatus for a dog according to the present embodiment is substantially the same as the display apparatus for a dog of FIG. 12 except for the method of generating the dog image data DIMG. Thus, the same reference numerals will be used to refer to the same or like parts as those described in the previous embodiment and any repetitive explanation concerning the above elements will be omitted.

Referring to FIGS. 1b and 14, when the third red grayscale value R″ is greater than the third blue grayscale value B″ and the third red grayscale value R″ is greater than the third green grayscale value G″, the dog filter 500 may determine the second blue grayscale value B′ by adding the first blue grayscale value B and the compensation value. When the third red grayscale value R″ is greater than the third blue grayscale value B″ and the third red grayscale value R″ is equal to or less than the third green grayscale value G″, the dog filter 500 may determine the first blue grayscale value B as the second blue grayscale value B′. When the third red grayscale value R″ is equal to or less than the third blue grayscale value B″ and the third red grayscale value R″ is greater than the third green grayscale value G″, the dog filter 500 may determine the first blue grayscale value B as the second blue grayscale value B′. When the third red grayscale value R″ is equal to or less than the third blue grayscale value B″ and the third red grayscale value R″ is equal to or less than the third green grayscale value G″, the dog filter 500 may determine the first blue grayscale value B as the second blue grayscale value B′. As a difference between the third red grayscale value R″ and the third blue grayscale value B″ increases, the compensation value may increase.

When the third red grayscale value R″ is greater than the third blue grayscale value B″ and the third red grayscale value R″ is greater than the third green grayscale value G″, the dog filter 500 may determine the second blue grayscale value B′ by adding the first blue grayscale value B and the compensation value. Thus, when the third red grayscale value R″ is greater than the third blue grayscale value B″ and the third red grayscale value R″ is greater than the third green grayscale value G″, the second blue grayscale value B′ may be greater than the first blue grayscale value B′. The dog filter 500 may convert the input image data IMG to the dog image data DIMG having a high blue ratio.

As the difference between the third red grayscale value R″ and the third blue grayscale value B″ increases, the compensation value may increase. As the difference between the third red grayscale value R″ and the third blue grayscale value B″ increases, a blue ratio of the input image data IMG may decrease. Thus, as the difference between the third red grayscale value R″ and the third blue grayscale value B″ increases, the compensation value may increase.

When the third red grayscale value R″ is greater than the third blue grayscale value B″ and the third red grayscale value R″ is equal to or less than the third green grayscale value G″, the dog filter 500 may determine the first blue grayscale value B as the second blue grayscale value B′. When the third red grayscale value R″ is equal to or less than the third blue grayscale value B″ and the third red grayscale value R″ is greater than the third green grayscale value G″, the dog filter 500 may determine the first blue grayscale value B as the second blue grayscale value B′. When the third red grayscale value R″ is equal to or less than the third blue grayscale value B″ and the third red grayscale value R″ is equal to or less than the third green grayscale value G″, the dog filter 500 may determine the first blue grayscale value B as the second blue grayscale value B′. When the third red grayscale value R″ is equal to or less than the third blue grayscale value B″, the blue ratio of the input image data IMG is already high so that the dog filter 500 may determine the first blue grayscale value B as the second blue grayscale value B′.

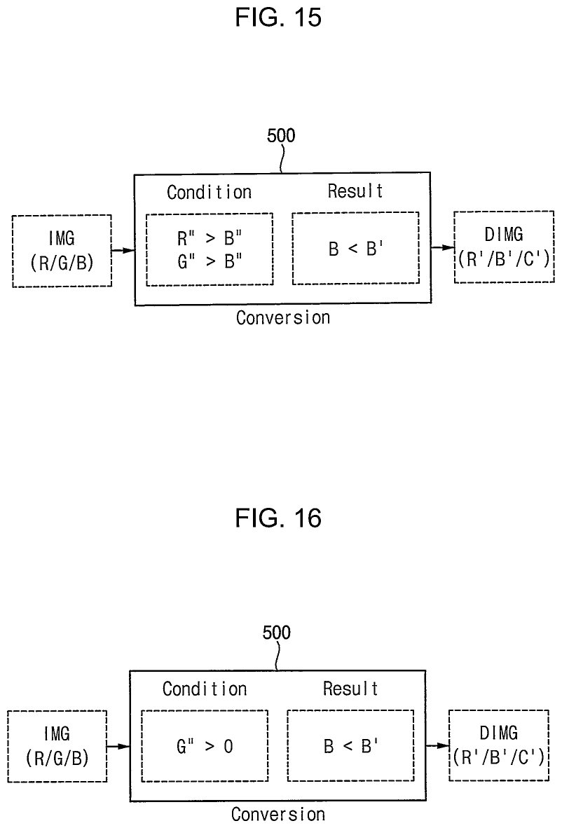

FIG. 15 is a conceptual diagram illustrating a dog filter 500 of a display apparatus for a dog according to embodiments of the present inventive concept.

The display apparatus for a dog according to the present embodiment is substantially the same as the display apparatus 1000 for a dog of FIG. 12 except for the method of generating the dog image data DIMG. Thus, the same reference numerals will be used to refer to the same or like parts as those described in the previous embodiment and any repetitive explanation concerning the above elements will be omitted.

Referring to FIGS. 1b and 15, when the third red grayscale value R″ is greater than the third blue grayscale value B″ and the third green grayscale value G″ is greater than the third blue grayscale value B″, the dog filter 500 may determine the second blue grayscale value B′ by adding the first blue grayscale value B and the compensation value. When the third red grayscale value R″ is greater than the third blue grayscale value B″ and the third green grayscale value G″ is equal to or less than the third blue grayscale value B″ of the green image data of the input image data, the dog filter 500 may determine the first blue grayscale value B as the second blue grayscale value B′. When the third red grayscale value R″ is equal to or less than the third blue grayscale value B″ and the third green grayscale value G″ is greater than the third blue grayscale value B″, the dog filter 500 may determine the first blue grayscale value B as the second blue grayscale value B′. When the third red grayscale value R″ is equal to or less than the third blue grayscale value B″ and the third green grayscale value G″ is equal to or less than the third blue grayscale value B″, the dog filter 500 may determine the first blue grayscale value B as the second blue grayscale value B′. As a difference between the third red grayscale value R″ and the third blue grayscale value B″ increases, the compensation value may increase.

When the third red grayscale value R″ is greater than the third blue grayscale value B″ and the third green grayscale value G″ is greater than the third blue grayscale value B″, the dog filter 500 may determine the second blue grayscale value B′ by adding the first blue grayscale value B and the compensation value. Thus, when the third red grayscale value R″ is greater than the third blue grayscale value B″ and the third green grayscale value G″ is greater than the third blue grayscale value B″, the second blue grayscale value B′ may be greater than the first blue grayscale value B. The dog filter 500 may convert the input image data IMG to the dog image data DIMG having a high blue ratio.

In an embodiment, as the difference between the third red grayscale value R″ and the third blue grayscale value B″ increases, the compensation value may increase. As the difference between the third red grayscale value R″ and the third blue grayscale value B″ increases, a blue ratio of the input image data IMG may decrease. Thus, as the difference between the third red grayscale value R″ and the third blue grayscale value B″ increases, the compensation value may increase.

In an embodiment, as the difference between the third green grayscale value G″ and the third blue grayscale value B″ increases, the compensation value may increase. As the difference between the third green grayscale value G″ and the third blue grayscale value B″ increases, a blue ratio of the input image data IMG may decrease. Thus, as the difference between the third green grayscale value G″ and the third blue grayscale value B″ increases, the compensation value may increase.

In an embodiment, as a sum of the difference between the third red grayscale value R″ and the third blue grayscale value B″ and the difference between the third green grayscale value G″ and the third blue grayscale value B″ increases, the compensation value may increase. As the sum of the difference between the third red grayscale value R″ and the third blue grayscale value B″ and the difference between the third green grayscale value G″ and the third blue grayscale value B″ increases, a blue ratio of the input image data IMG may decrease. Thus, as the sum of the difference between the third red grayscale value R″ and the third blue grayscale value B″ and the difference between the third green grayscale value G″ and the third blue grayscale value B″ increases, the compensation value may increase.

When the third red grayscale value R″ is greater than the third blue grayscale value B″ and the third green grayscale value G″ is equal to or less than the third blue grayscale value B″ of the green image data of the input image data, the dog filter 500 may determine the first blue grayscale value B as the second blue grayscale value B′. When the third red grayscale value R″ is equal to or less than the third blue grayscale value B″ and the third green grayscale value G″ is greater than the third blue grayscale value B″, the dog filter 500 may determine the first blue grayscale value B as the second blue grayscale value B′. When the third red grayscale value R″ is equal to or less than the third blue grayscale value B″ and the third green grayscale value G″ is equal to or less than the third blue grayscale value B″, the dog filter 500 may determine the first blue grayscale value B as the second blue grayscale value B′. Dogs may recognize red and green as yellow and recognize blue as blue so that the blue ratio of the input image data IMG is already high when the one of the third red grayscale value R″ and the third green grayscale value G″ is equal to or less than the third blue grayscale value B″. Thus, when the one of the third red grayscale value R″ and the third green grayscale value G″ is equal to or less than the third blue grayscale value B″, the dog filter 500 may determine the first blue grayscale value B as the second blue grayscale value B′.

FIG. 16 is a conceptual diagram illustrating a dog filter 500 of a display apparatus for a dog according to embodiments of the present inventive concept.

The display apparatus for a dog according to the present embodiment is substantially the same as the display apparatus for a dog of FIG. 12 except for the method of generating the dog image data DIMG. Thus, the same reference numerals will be used to refer to the same or like parts as those described in the previous embodiment and any repetitive explanation concerning the above elements will be omitted.

Referring to FIGS. 1b and 16, when a third green grayscale value G″ is greater than zero, the dog filter 500 may determine the second blue grayscale value B′ of the dog image data DIMG by adding the first blue grayscale value B of the input image data IMG and the compensation value. When the third green grayscale value G″ is zero, the dog filter 500 may determine the first blue grayscale value B as the second blue grayscale value B′. As the third green grayscale value G″ increases, the compensation value may increase. For example, the compensation value may be greater than zero.

When the third green grayscale value G″ is greater than zero, the dog filter 500 may determine the second blue grayscale value B′ by adding the first blue grayscale value B and the compensation value. Thus, when third green grayscale value G″ is greater than zero, the second blue grayscale value B′ may be greater than the first blue grayscale value B. The dog filter 500 may convert the input image data IMG to the dog image data DIMG having a high blue ratio.

As the third green grayscale value G″ increases, the compensation value may increase. As the third green grayscale value G″ increases, a blue ratio of the input image data IMG may decrease. Thus, as the third green grayscale value G″ increases, the compensation value may increase.

When the third green grayscale value G″ is zero, the dog filter 500 may determine the first blue grayscale value B as the second blue grayscale value B′. When the third green grayscale value G″ is zero, the blue ratio of the input image data IMG is already high so that the dog filter 500 may determine the first blue grayscale value B as the second blue grayscale value B′.

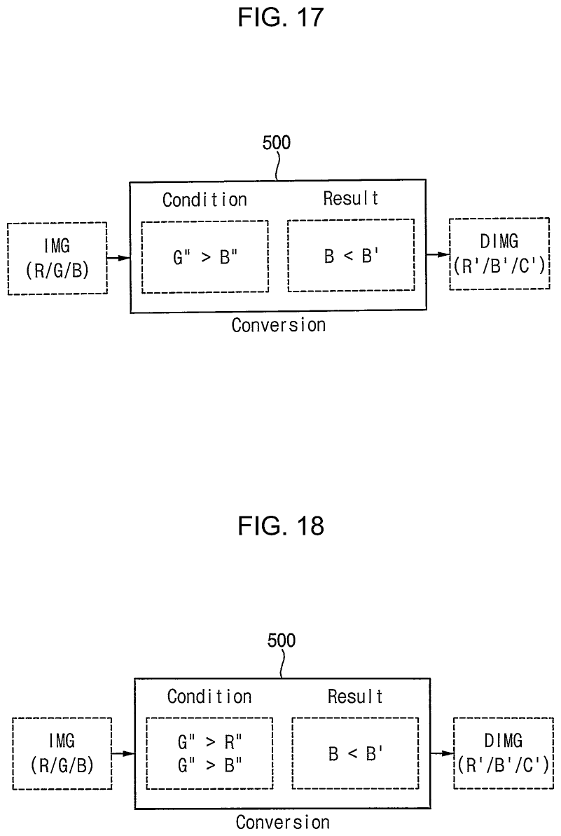

FIG. 17 is a conceptual diagram illustrating a dog filter 500 of a display apparatus for a dog according to embodiments of the present inventive concept.

The display apparatus for a dog according to the present embodiment is substantially the same as the display apparatus for a dog of FIG. 16 except for the method of generating the dog image data DIMG. Thus, the same reference numerals will be used to refer to the same or like parts as those described in the previous embodiment and any repetitive explanation concerning the above elements will be omitted.

Referring to FIGS. 1b and 17, when the third green grayscale value G″ is greater than the third blue grayscale value B″, the dog filter 500 may determine the second blue grayscale value B′ by adding the first blue grayscale value B and the compensation value. When the third green grayscale value G″ is equal to or less than the third blue grayscale value B″, the dog filter 500 may determine the first blue grayscale value B as the second blue grayscale value B′. As a difference between the third green grayscale value G″ and the third blue grayscale value B″ increases, the compensation value may increase.

When the third green grayscale value G″ is greater than the third blue grayscale value B″, the dog filter 500 may determine the second blue grayscale value B′ by adding the first blue grayscale value B and the compensation value. Thus, when the third green grayscale value G″ is greater than the third blue grayscale value B″, the second blue grayscale value B′ may be greater than the first blue grayscale value B. The dog filter 500 may convert the input image data IMG to the dog image data DIMG having a high blue ratio.

As the difference between the third green grayscale value G″ and the third blue grayscale value B″ increases, the compensation value may increase. As the difference between the third green grayscale value G″ and the third blue grayscale value B″ increases, a blue ratio of the input image data IMG may decrease. Thus, as the difference between the third green grayscale value G″ and the third blue grayscale value B″ increases, the compensation value may increase.

When the third green grayscale value G″ is equal to or less than the third blue grayscale value B″, the dog filter 500 may determine the first blue grayscale value B as the second blue grayscale value B′. When the third green grayscale value G″ is equal to or less than the third blue grayscale value B″, the blue ratio of the input image data IMG is already high so that the dog filter 500 may determine the first blue grayscale value B as the second blue grayscale value B′.

FIG. 18 is a conceptual diagram illustrating a dog filter 500 of a display apparatus for a dog according to embodiments of the present inventive concept.

The display apparatus for a dog according to the present embodiment is substantially the same as the display apparatus for a dog of FIG. 16 except for the method of generating the dog image data DIMG. Thus, the same reference numerals will be used to refer to the same or like parts as those described in the previous embodiment and any repetitive explanation concerning the above elements will be omitted.

Referring to FIGS. 1b and 18, when the third green grayscale value G″ is greater than the third blue grayscale value B″ and the third green grayscale value G″ is greater than the third red grayscale value R″, the dog filter 500 may determine the second blue grayscale value B′ by adding the first blue grayscale value B and the compensation value. When the third green grayscale value G″ is greater than the third blue grayscale value B″ and the third green grayscale value G″ is equal to or less than the third red grayscale value R″, the dog filter 500 may determine the first blue grayscale value B as the second blue grayscale value B′. When the third green grayscale value G″ is equal to or less than the third blue grayscale value B″ and the third green grayscale value G″ is greater than the third red grayscale value R″, the dog filter 500 may determine the first blue grayscale value B as the second blue grayscale value B′. When the third green grayscale value G″ is equal to or less than the third blue grayscale value B″ and the third green grayscale value G″ is equal to or less than the third red grayscale value R″, the dog filter 500 may determine the first blue grayscale value B as the second blue grayscale value B′. As a difference between the third green grayscale value G″ and the third blue grayscale value B″ increases, the compensation value may increase.

When the third green grayscale value G″ is greater than the third blue grayscale value B″ and the third green grayscale value G″ is greater than the third red grayscale value R″, the dog filter 500 may determine the second blue grayscale value B′ by adding the first blue grayscale value B and the compensation value. Thus, when the third green grayscale value G″ is greater than the third blue grayscale value B″ and the third green grayscale value G″ is greater than the third red grayscale value R″, the second blue grayscale value B′ may be greater than the first blue grayscale value B. The dog filter 500 may convert the input image data IMG to the dog image data DIMG having a high blue ratio.

As the difference between the third green grayscale value G″ and the third blue grayscale value B″ increases, the compensation value may increase. As the difference between the third green grayscale value G″ and the third blue grayscale value B″ increases, a blue ratio of the input image data IMG may decrease. Thus, as the difference between the third green grayscale value G″ and the third blue grayscale value B″ increases, the compensation value may increase.

When the third green grayscale value G″ is greater than the third blue grayscale value B″ and the third green grayscale value G″ is equal to or less than the third red grayscale value R″, the dog filter 500 may determine the first blue grayscale value B as the second blue grayscale value B′. When the third green grayscale value G″ is equal to or less than the third blue grayscale value B″ and the third green grayscale value G″ is greater than the third red grayscale value R″, the dog filter 500 may determine the first blue grayscale value B as the second blue grayscale value B′. When the third green grayscale value G″ is equal to or less than the third blue grayscale value B″ and the third green grayscale value G″ is equal to or less than the third red grayscale value R″, the dog filter 500 may determine the first blue grayscale value B as the second blue grayscale value B′. When the third green grayscale value G″ is equal to or less than the third blue grayscale value B″, the blue ratio of the input image data IMG is already high so that the dog filter 500 may determine the first blue grayscale value B as the second blue grayscale value B′.

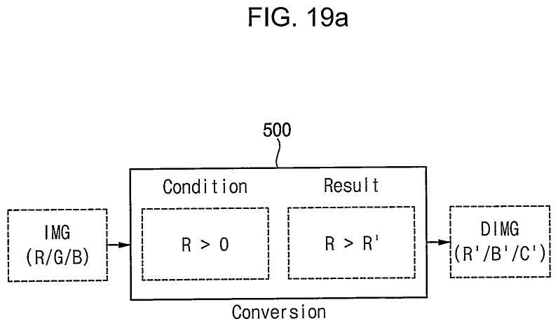

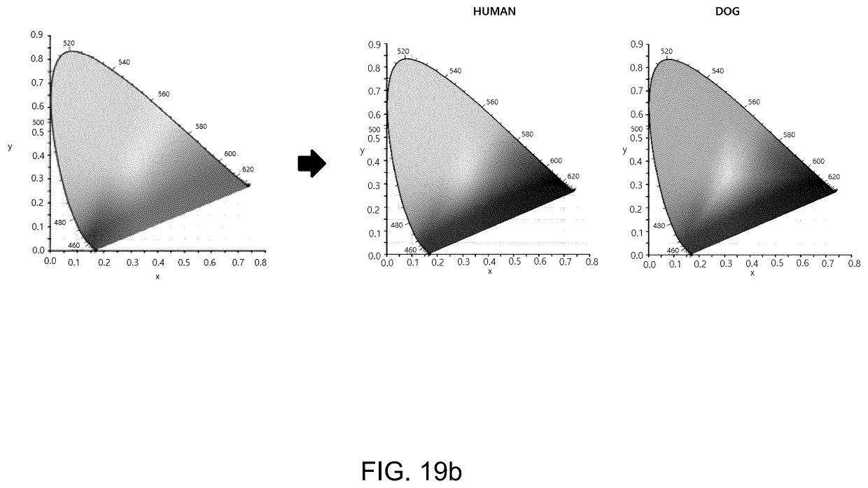

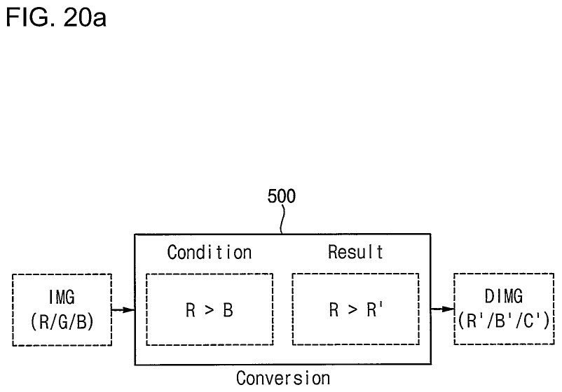

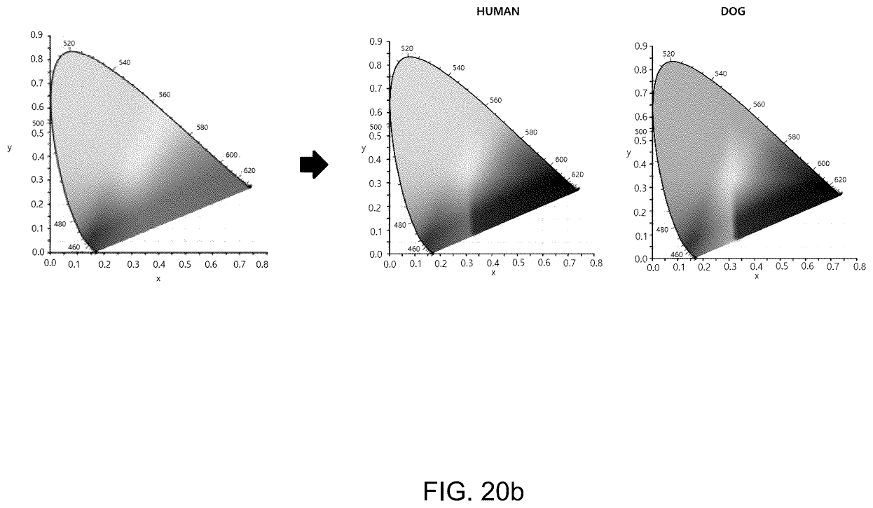

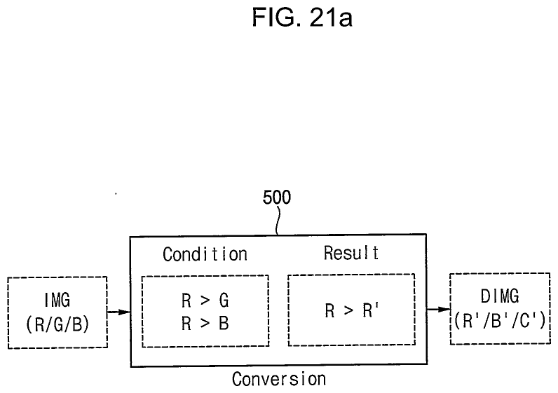

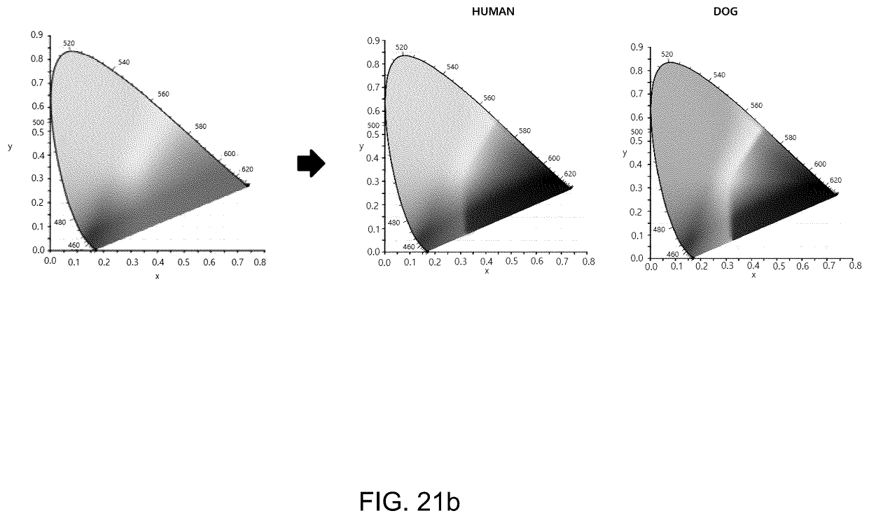

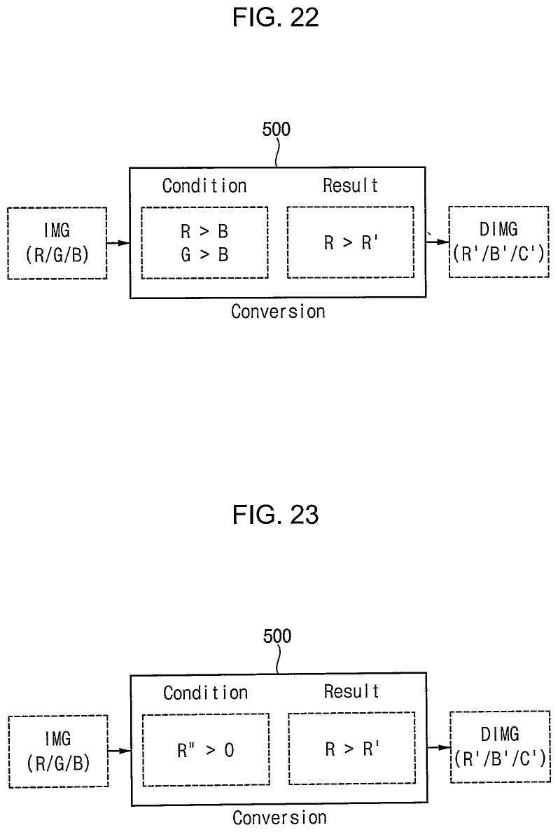

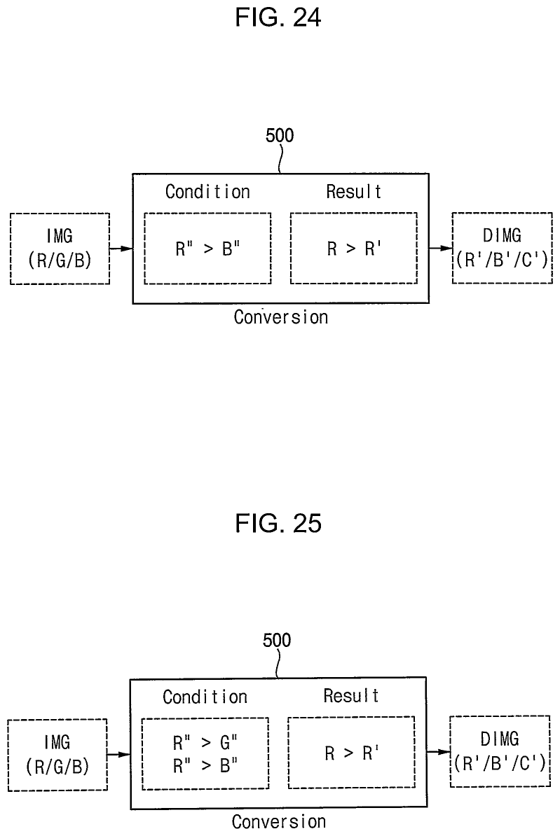

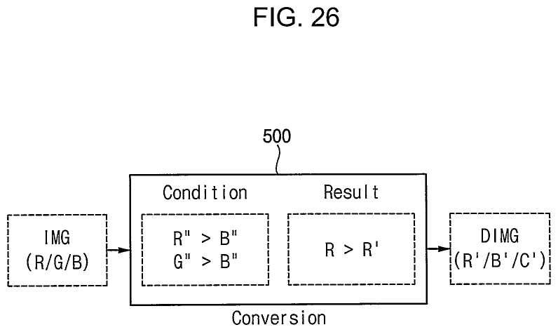

FIGS. 19a, 20a, 21a and 22 to 26 are conceptual diagrams illustrating dog filters 500 of display apparatuses for a dog according to embodiments of the present inventive concept, FIG. 19b is a diagram illustrating an example of a color change according to the dog filter 500 of FIG. 19a, FIG. 20b is a diagram illustrating an example of a color change according to the dog filter 500 of FIG. 20a, FIG. 21b is a diagram illustrating an example of a color change according to the dog filter 500 of FIG. 21a and FIG. 27 is a diagram illustrating color coordinates of the display apparatuses for a dog of FIGS. 19a to 26. A left graph of each of FIGS. 19b, 20b and 21b illustrates color coordinates of a human for the input image data IMG and two right graphs of each of FIGS. 19b, 20b and 21b illustrate color coordinates of a human and color coordinates of a dog for the dog image data DIMG.

The display apparatuses for a dog according to the present embodiments are substantially the same as the display apparatuses for a dog of FIGS. 1b, 5a, 6a, 7a and 12 to 15 except that the display apparatuses for a dog subtract the compensation value from the first red grayscale value R instead of adding the compensation value to the first blue grayscale value B. Thus, the same reference numerals will be used to refer to the same or like parts as those described in the previous embodiments and any repetitive explanation concerning the above elements will be omitted.

Referring to FIGS. 1b and 19a to 27, the dog filter 500 may determine a second red grayscale value R′ of the dog image data DIMG by subtracting a compensation value from the first red grayscale value R. For example, the compensation value may be greater than zero. When the second red grayscale value R′is determined by subtracting the compensation value from the first red grayscale value R, the second red grayscale value R′ may be less than the first red grayscale value R. Thus, the dog filter 500 may decrease a yellow ratio (because a dog recognizes red and green as yellow) so that the dog filter 500 may convert the input image data IMG to the dog image data DIMG having a high blue ratio.

Referring to FIGS. 2 and 27, the color space of FIG. 27 may represent a converted color space from the color space CS2 of FIG. 2. In converted color spaces of the display apparatuses for a dog of FIGS. 19a to 26, coordinates of red (a right vertex of the triangle) may be converted compared to the second color space CS2.

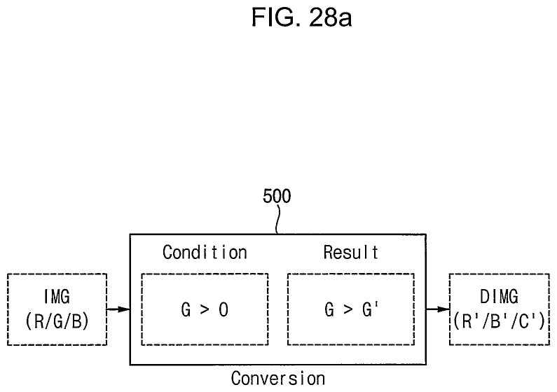

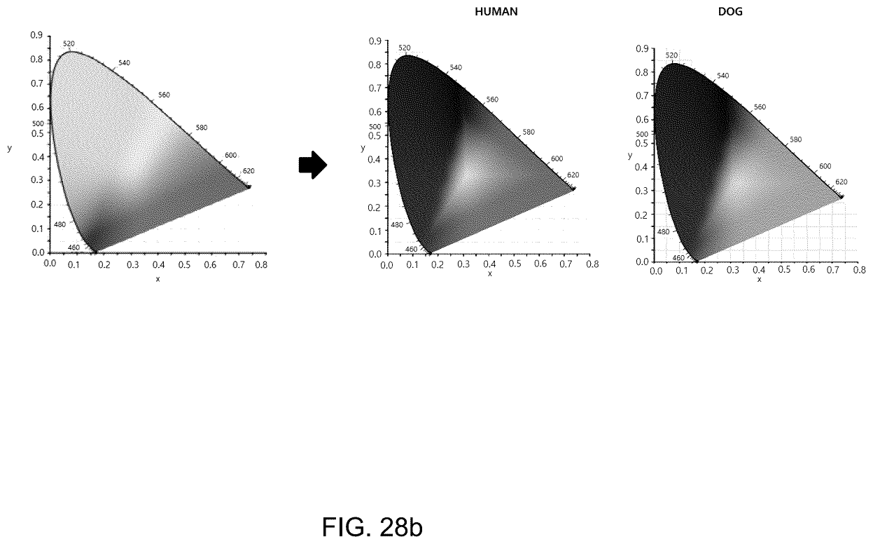

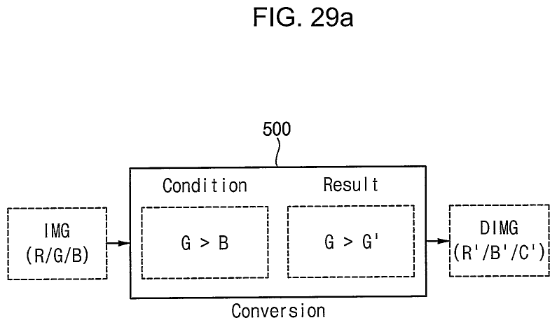

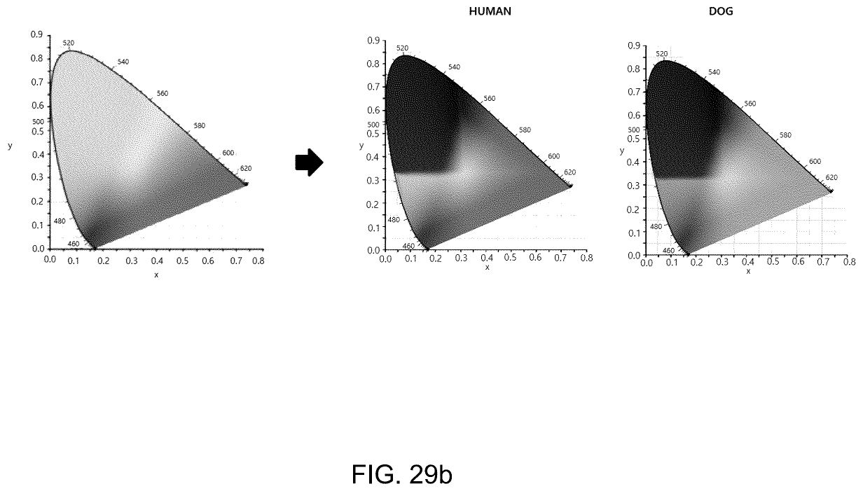

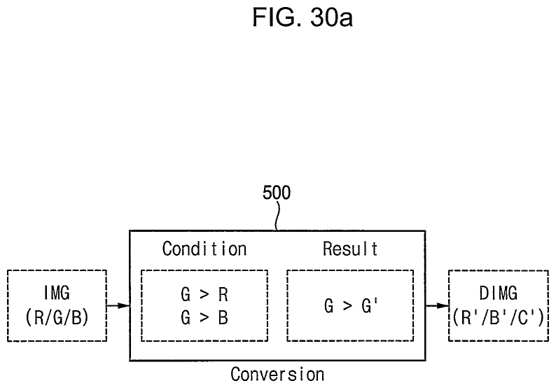

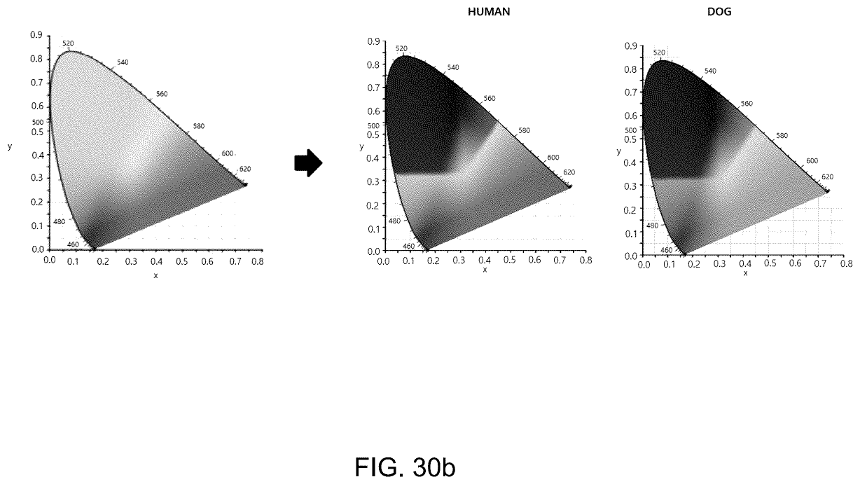

FIGS. 28a, 29a and 30a are conceptual diagrams illustrating dog filters 500 of display apparatuses for a dog according to embodiments of the present inventive concept. FIG. 28b is a diagram illustrating an example of a color change according to the dog filter 500 of FIG. 28a. FIG. 29b is a diagram illustrating an example of a color change according to the dog filter 500 of FIG. 29a. FIG. 30b is a diagram illustrating an example of a color change according to the dog filter 500 of FIG. 30a. A left graph of each of FIGS. 28b, 29b and 30b illustrates color coordinates of a human for the input image data IMG and two right graphs of each of FIGS. 28b, 29b and 30b illustrate color coordinates of a human and color coordinates of a dog for the dog image data DIMG.

The display apparatuses for a dog according to the present embodiments are substantially the same as the display apparatuses for a dog of FIGS. 8a, 9a and 10a except that the display apparatuses for a dog subtract the compensation value from the first green grayscale value G instead of adding the compensation value to the first blue grayscale value B. Thus, the same reference numerals will be used to refer to the same or like parts as those described in the previous embodiments and any repetitive explanation concerning the above elements will be omitted.

Referring to FIGS. 1b and 28a to 30b, the dog filter 500 may determine a second green grayscale value G′ of the dog image data DIMG by subtracting a compensation value from the first green grayscale value G. For example, the compensation value may be greater than zero. When the second green grayscale value G′ is determined by subtracting the compensation value from the first green grayscale value G, the second green grayscale value G′ may be less than the first green grayscale value G. Thus, the dog filter 500 may decrease a yellow ratio (because a dog recognizes red and green as yellow) so that the dog filter 500 may convert the input image data IMG to the dog image data DIMG having a high blue ratio.

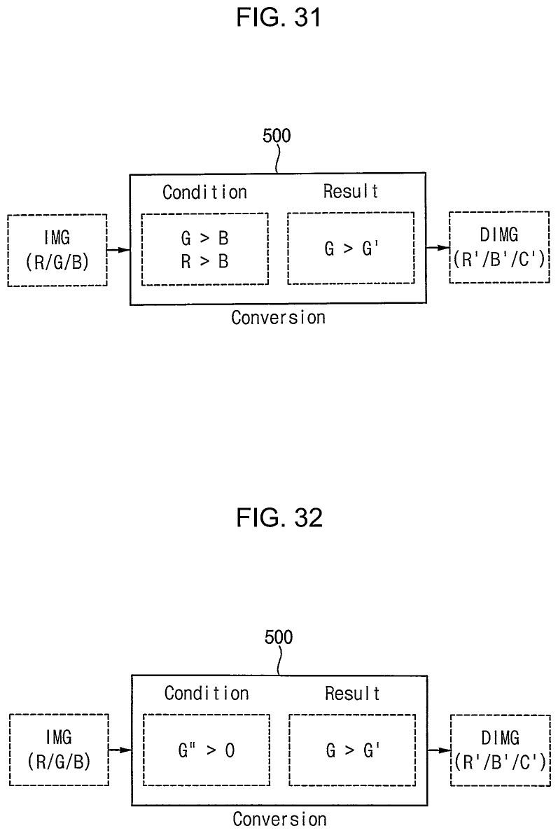

FIG. 31 is a conceptual diagram illustrating a dog filter 500 of a display apparatus for a dog according to embodiments of the present inventive concept.

The display apparatus for a dog according to the present embodiment is substantially the same as the display apparatus for a dog of FIG. 7a except that the display apparatus for a dog subtracts the compensation value from the first green grayscale value G instead of adding the compensation value to the first blue grayscale value B. Thus, the same reference numerals will be used to refer to the same or like parts as those described in the previous embodiment and any repetitive explanation concerning the above elements will be omitted.

Referring to FIGS. 1b and 31, the dog filter 500 may determine the second green grayscale value G′ by subtracting a compensation value from the first green grayscale value G. For example, the compensation value may be greater than zero. When the second green grayscale value G′ is determined by subtracting the compensation value from the first green grayscale value G, the second green grayscale value G′ may be less than the first green grayscale value G. Thus, the dog filter 500 may decrease a yellow ratio (because a dog recognizes red and green as yellow) so that the dog filter 500 may convert the input image data IMG to the dog image data DIMG having a high blue ratio.

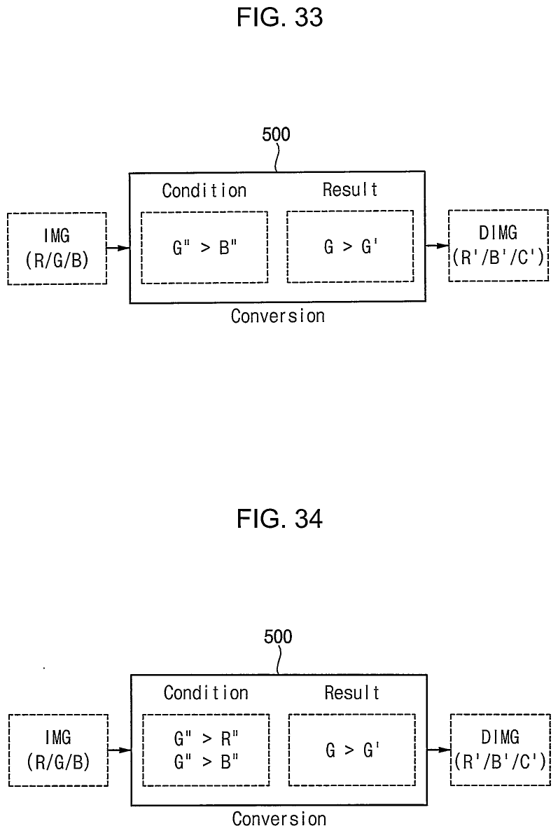

FIGS. 32 to 34 are conceptual diagrams illustrating dog filters 500 of display apparatuses for a dog according to embodiments of the present inventive concept.

The display apparatuses for a dog according to the present embodiments are substantially the same as the display apparatuses for a dog of FIGS. 16 to 18 except that the display apparatuses for a dog subtract the compensation value from the first green grayscale value G instead of adding the compensation value to the first blue grayscale value B. Thus, the same reference numerals will be used to refer to the same or like parts as those described in the previous embodiments and any repetitive explanation concerning the above elements will be omitted.

Referring to FIGS. 1b and 32 to 34, the dog filter 500 may determine a second green grayscale value G′ of the dog image data DIMG by subtracting a compensation value from the first green grayscale value G. For example, the compensation value may be greater than zero. When the second green grayscale value G′ is determined by subtracting the compensation value from the first green grayscale value G, the second green grayscale value G′ may be less than the first green grayscale value G. Thus, the dog filter 500 may decrease a yellow ratio (because a dog recognizes red and green as yellow) so that the dog filter 500 may convert the input image data IMG to the dog image data DIMG having a high blue ratio.

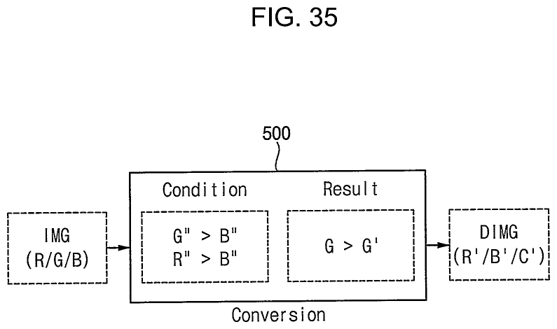

FIG. 35 is a conceptual diagram illustrating a dog filter 500 of a display apparatus for a dog according to embodiments of the present inventive concept.

The display apparatus for a dog according to the present embodiment is substantially the same as the display apparatus for a dog of FIG. 15 except that the display apparatus for a dog subtracts the compensation value from the first green grayscale value G instead of adding the compensation value to the first blue grayscale value B. Thus, the same reference numerals will be used to refer to the same or like parts as those described in the previous embodiment and any repetitive explanation concerning the above elements will be omitted.

Referring to FIGS. 1b and 35, the dog filter 500 may determine the second green grayscale value G′ by subtracting a compensation value from the first green grayscale value G. For example, the compensation value may be greater than zero. When the second green grayscale value G′ is determined by subtracting the compensation value from the first green grayscale value G, the second green grayscale value G′ may be less than the first green grayscale value G. Thus, the dog filter 500 may decrease a yellow ratio (because a dog recognizes red and green as yellow) so that the dog filter 500 may convert the input image data IMG to the dog image data DIMG having a high blue ratio.

FIG. 36 is a diagram illustrating color coordinates of the display apparatuses for a dog of FIGS. 28a to 35.

Referring to FIGS. 2 and 36, the color space of FIG. 36 may represent a converted color space from the color space CS2 of FIG. 2. In converted color spaces of the display apparatuses for a dog of FIGS. 28a to 35, coordinates of green (an upper vertex of the triangle) may be converted compared to the second color space CS2.

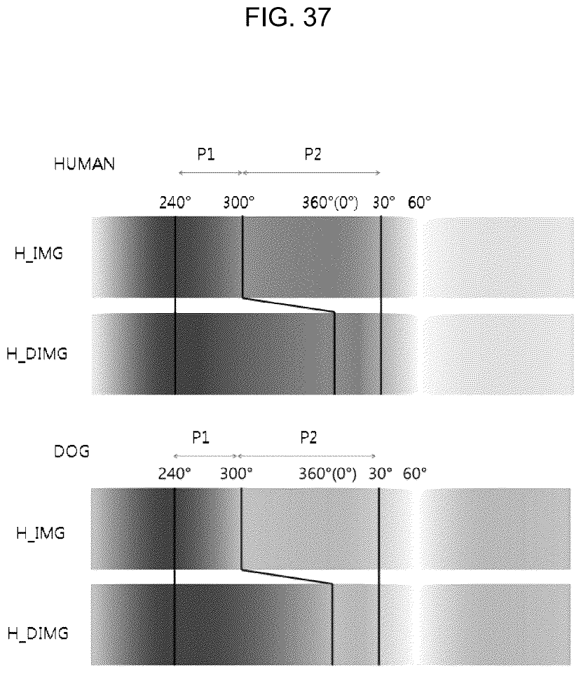

FIG. 37 is a diagram illustrating color values H_IMG of input image data IMG and color values H_DIMG of dog image data DIMG of a display apparatus for a dog according to embodiments of the present inventive concept.

The display apparatus for a dog according to the present embodiment is substantially the same as the display apparatus 1000 for a dog of FIG. 1b except for the dog filter 500. Thus, the same reference numerals will be used to refer to the same or like parts as those described in the previous embodiment and any repetitive explanation concerning the above elements will be omitted.

Referring to FIGS. 1b and 37, the dog filter 500 may generate the dog image data DIMG by increasing the blue ratio of the input image data IMG. For example, the dog filter 500 may convert the input image data IMG in an RGB domain to input image data in an HSV domain, generate a dog image data in the HSV domain by expanding a blue range P1 of a color value H_IMG of the input image data in the HSV domain and reducing a red range P2 of the color value H_IMG of the input image data in the HSV domain, and generate the dog image data DIMG in the RGB domain based on the dog image data in the HSV domain. In another embodiment, the dog filter 500 may generate the dog image data in the HSV domain by expanding the blue range P1 of the color value H_IMG of the input image data in the HSV domain and reducing a green range of the color value H_IMG of the input image data in the HSV domain.

For example, the color value in the HSV domain may have a range between 0° and 360°. A range between 240° and 300° may represent the blue range P1 and a range between 300° and 360° and a range between 0° and 30° may represent the red range P2. The dog filter 500 may expand the blue range P1 to between 240° and 360° and may reduce the red range P2 to between 0° and 30°. Thus, a color of image displayed based on the input image data having the color value H_IMG of 300° may be same as a color of image displayed based on the dog image data having the color value H_DIMG of 360°. For example, a color of image displayed based on the input image data having the color value H_IMG of 270° may be same as a color of image displayed based on the dog image data having the color value H_DIMG of 300°.Accordingly, the blue ratio of the dog image data DIMG may be higher than the blue ratio of the input image data IMG.

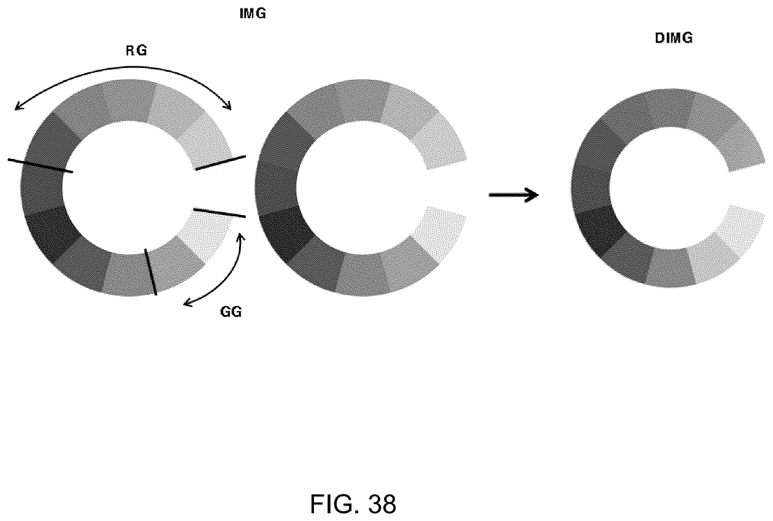

FIG. 38 is a diagram illustrating luminances for colors of a display apparatus for a dog according to embodiments of the present inventive concept.

The display apparatus for a dog according to the present embodiment is substantially the same as the display apparatus 1000 for a dog of FIG. 1b except for the dog filter 500. Thus, the same reference numerals will be used to refer to the same or like parts as those described in the previous embodiment and any repetitive explanation concerning the above elements will be omitted.

Referring to FIGS. 1b and 38, the dog filter 500 may generate the dog image data DIMG by increasing a difference between a luminance of a red range RG of the input image data IMG and a luminance of a green range GG of the input image data IMG.

For example, the dog filter 500 may convert the input image data IMG in an RGB domain to input image data IMG in a luminance domain and generate the dog image data DIMG by converting the luminance of the input image data in the luminance domain. For example, the luminance of the red range RG of the input image data IMG may be decreased and the luminance of the green range GG of the input image data IMG may be increased. For example, the dog filter 500 may further decrease the luminance of the red range RG as it is farther from yellow and further increase the luminance of the green range GG as it is farther from yellow. Thus, the red image and the green image may be distinguished by the difference of the luminance. Accordingly, a dog which cannot distinguish between red and green may distinguish between red and green images well.

### Industrial Availability

The present inventive concept may be applied to the display apparatus for a dog and an electronic apparatus including the display apparatus. For example, the present inventive concept may be applied to a digital TV, a 3D TV, a cellular phone, a smart phone, a tablet PC, a VR apparatus, a PC, a home electronic apparatus, a laptop, a PDA, a PMP, a digital camera, a music player, a portable game console, a navigation and so on.

Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims.

[EXPLANATION OF REFERENCE NUMBERS]

| | |
|---|---|
| 1000: DISPLAY APPARATUS | 1100: DISPLAY PANEL DRIVER |
| 100: DISPLAY PANEL | 200: DRIVING CONTROLLER |
| 300: GATE DRIVER | 400: DATA DRIVER |
| 500: DOG FILTER | |

1. A display apparatus for a dog comprising:
a display panel including pixels;
a dog filter which generates dog image data based on input image data and determine a second blue grayscale value of the dog image data by adding a first blue grayscale value of the input image data and a compensation value; and
a display panel driver which generates data voltages based on the dog image data and applies the data voltages to the pixels.

2. The display apparatus for a dog of claim 1, wherein the display panel driver activates the dog filter and generate the data voltages based on the dog image data in a dog mode, and
wherein the display panel driver deactivates the dog filter and generate the data voltages based on the input image data in a human mode.

3. The display apparatus for a dog of claim 1, wherein when a first red grayscale value of the input image data is greater than zero, the dog filter determines the second blue grayscale value by adding the first blue grayscale value and the compensation value, and
wherein when the first red grayscale value is zero, the dog filter determines the first blue grayscale value as the second blue grayscale value.

4. The display apparatus for a dog of claim 3, wherein as the first red grayscale value increases, the compensation value increases.

5. The display apparatus for a dog of claim 1, wherein when a first red grayscale value of the input image data is greater than the first blue grayscale value, the dog filter determines the second blue grayscale value by adding the first blue grayscale value and the compensation value, and
wherein when the first red grayscale value is equal to or less than the first blue grayscale value, the dog filter determines the first blue grayscale value as the second blue grayscale value.

6. The display apparatus for a dog of claim 5, wherein as a difference between the first red grayscale value and the first blue grayscale value increases, the compensation value increases.

7. The display apparatus for a dog of claim 1, wherein when a first red grayscale value of the input image data is greater than the first blue grayscale value and the first red grayscale value is greater than a first green grayscale value of the input image data, the dog filter determines the second blue grayscale value by adding the first blue grayscale value and the compensation value,
wherein when the first red grayscale value is greater than the first blue grayscale value and the first red grayscale value is equal to or less than the first green grayscale value, the dog filter determines the first blue grayscale value as the second blue grayscale value,
wherein when the first red grayscale value is equal to or less than the first blue grayscale value and the first red grayscale value is greater than the first green grayscale value, the dog filter determines the first blue grayscale value as the second blue grayscale value, and
wherein when the first red grayscale value is equal to or less than the first blue grayscale value and the first red grayscale value is equal to or less than the first green grayscale value, the dog filter determines the first blue grayscale value as the second blue grayscale value.

8. The display apparatus for a dog of claim 1, wherein when a first red grayscale value of the input image data is greater than the first blue grayscale value and a first green grayscale value of the input image data is greater than the first blue grayscale value, the dog filter determines the second blue grayscale value by adding the first blue grayscale value and the compensation value,
wherein when the first red grayscale value is greater than the first blue grayscale value and the first green grayscale value is equal to or less than the first blue grayscale value, the dog filter determines the first blue grayscale value as the second blue grayscale value,
wherein when the first red grayscale value is equal to or less than the first blue grayscale value and the first green grayscale value is greater than the first blue grayscale value, the dog filter determines the first blue grayscale value as the second blue grayscale value, and
wherein when the first red grayscale value is equal to or less than the first blue grayscale value and the first green grayscale value is equal to or less than the first blue grayscale value, the dog filter determines the first blue grayscale value as the second blue grayscale value.

9. The display apparatus for a dog of claim 8, wherein as a difference between the first red grayscale value and the first blue grayscale value increases, the compensation value increases.

10. The display apparatus for a dog of claim 8, wherein as a difference between the first green grayscale value and the first blue grayscale value increases, the compensation value increases.

11. The display apparatus for a dog of claim 8, wherein as a sum of a difference between the first red grayscale value and the first blue grayscale value and a difference between the first green grayscale value and the first blue grayscale value increases, the compensation value increases.

12. The display apparatus for a dog of claim 1, wherein when a first green grayscale value of the input image data is greater than zero, the dog filter determines the second blue grayscale value by adding the first blue grayscale value and the compensation value, and
wherein when the first green grayscale value is zero, the dog filter determines the first blue grayscale value as the second blue grayscale value.

13. The display apparatus for a dog of claim 1, wherein when a first green grayscale value of the input image data is greater than the first blue grayscale value, the dog filter determines the second blue grayscale value by adding the first blue grayscale value and the compensation value, and
wherein when the first green grayscale value is equal to or less than the first blue grayscale value, the dog filter determines the first blue grayscale value as the second blue grayscale value.

14. The display apparatus for a dog of claim 1, wherein when a first green grayscale value of the input image data is greater than the first blue grayscale value and the first green grayscale value is greater than a first red grayscale value of the input image data, the dog filter determines the second blue grayscale value by adding the first blue grayscale value and the compensation value,
wherein when the first green grayscale value is greater than the first blue grayscale value and the first green grayscale value is equal to or less than the first red grayscale value, the dog filter determines the first blue grayscale value as the second blue grayscale value,
wherein when the first green grayscale value is equal to or less than the first blue grayscale value and the first green grayscale value is greater than the first red grayscale value, the dog filter determines the first blue grayscale value as the second blue grayscale value, and
wherein when the first green grayscale value is equal to or less than the first blue grayscale value and the first green grayscale value is equal to or less than the first red grayscale value, the dog filter determines the first blue grayscale value as the second blue grayscale value.

15. The display apparatus for a dog of claim 1, wherein the dog filter generates a third red grayscale value by converting a first red grayscale value of an RGB domain of the input image data into a sensitivity domain reflecting visual characteristics of dogs,
wherein the dog filter is generates a third blue grayscale value by converting the first blue grayscale value B of the RGB domain into the sensitivity domain, and
wherein the dog filter generates a third green grayscale value by converting a first green grayscale value of the RGB domain of the input image data into the sensitivity domain.

16. The display apparatus for a dog of claim 15, wherein when the third red grayscale value is greater than the third blue grayscale value, the dog filter determines the second blue grayscale value by adding the first blue grayscale value and the compensation value, and
wherein when the third red grayscale value is equal to or less than the third blue grayscale value, the dog filter determines the first blue grayscale value as the second blue grayscale value.

17. The display apparatus for a dog of claim 15, wherein when the third red grayscale value is greater than the third blue grayscale value and the third red grayscale value is greater than the third green grayscale value, the dog filter determines the second blue grayscale value by adding the first blue grayscale value and the compensation value,
wherein when the third red grayscale value is greater than the third blue grayscale value and the third red grayscale value is equal to or less than the third green grayscale value, the dog filter determines the first blue grayscale value as the second blue grayscale value,
wherein when the third red grayscale value is equal to or less than the third blue grayscale value and the third red grayscale value is greater than the third green grayscale value, the dog filter determines the first blue grayscale value as the second blue grayscale value, and
wherein when the third red grayscale value is equal to or less than the third blue grayscale value and the third red grayscale value is equal to or less than the third green grayscale value, the dog filter determines the first blue grayscale value as the second blue grayscale value.

18. The display apparatus for a dog of claim 15, wherein when the third red grayscale value is greater than the third blue grayscale value and the third green grayscale value is greater than the third blue grayscale value, the dog filter determines the second blue grayscale value by adding the first blue grayscale value and the compensation value,
wherein when the third red grayscale value is greater than the third blue grayscale value and the third green grayscale value is equal to or less than the third blue grayscale value, the dog filter determines the first blue grayscale value as the second blue grayscale value,
wherein when the third red grayscale value is equal to or less than the third blue grayscale value and the third green grayscale value is greater than the third blue grayscale value, the dog filter determines the first blue grayscale value as the second blue grayscale value, and
wherein when the third red grayscale value is equal to or less than the third blue grayscale value and the third green grayscale value is equal to or less than the third blue grayscale value, the dog filter determines the first blue grayscale value as the second blue grayscale value.

19. The display apparatus for a dog of claim 15, wherein when the third green grayscale value is greater than the third blue grayscale value, the dog filter determines the second blue grayscale value by adding the first blue grayscale value and the compensation value, and
wherein when the third green grayscale value is equal to or less than the third blue grayscale value, the dog filter determines the first blue grayscale value as the second blue grayscale value.

20. The display apparatus for a dog of claim 15, wherein when the third green grayscale value is greater than the third blue grayscale value and the third green grayscale value is greater than the third red grayscale value, the dog filter determines the second blue grayscale value by adding the first blue grayscale value and the compensation value,
wherein when the third green grayscale value is greater than the third blue grayscale value and the third green grayscale value is equal to or less than the third red grayscale value, the dog filter determines the first blue grayscale value as the second blue grayscale value,
wherein when the third green grayscale value is equal to or less than the third blue grayscale value and the third green grayscale value is greater than the third red grayscale value, the dog filter determines the first blue grayscale value as the second blue grayscale value, and
wherein when the third green grayscale value is equal to or less than the third blue grayscale value and the third green grayscale value is equal to or less than the third red grayscale value, the dog filter determines the first blue grayscale value as the second blue grayscale value.

21. A display apparatus for a dog comprising:
a display panel including pixels;
a dog filter which generates dog image data based on input image data and determine a second red grayscale value of the dog image data by subtracting a compensation value from a first red grayscale value of the input image data; and
a display panel driver which generates data voltages based on the dog image data and applies the data voltages to the pixels.

22. The display apparatus for a dog of claim 21, wherein when the first red grayscale value is greater than zero, the dog filter determines the second red grayscale value by subtracting the compensation value from the first red grayscale value, and
wherein when the first red grayscale value is zero, the dog filter determines the first red grayscale value as the second red grayscale value.

23. The display apparatus for a dog of claim 21, wherein when the first red grayscale value is greater than a first blue grayscale value of the input image data, the dog filter determines the second red grayscale value by subtracting the compensation value from the first red grayscale value, and
wherein when the first red grayscale value is equal to or less than the first blue grayscale value, the dog filter determines the first red grayscale value as the second red grayscale value.

24. The display apparatus for a dog of claim 21, wherein when the first red grayscale value is greater than a first blue grayscale value of the input image data and the first red grayscale value is greater than a first green grayscale value of the input image data, the dog filter determines the second red grayscale value by subtracting the compensation value from the first red grayscale value,
wherein when the first red grayscale value is greater than the first blue grayscale value and the first red grayscale value is equal to or less than the first green grayscale value, the dog filter determines the first red grayscale value as the second red grayscale value,
wherein when the first red grayscale value is equal to or less than the first blue grayscale value and the first red grayscale value is greater than the first green grayscale value, the dog filter determines the first red grayscale value as the second red grayscale value, and
wherein when the first red grayscale value is equal to or less than the first blue grayscale value and the first red grayscale value is equal to or less than the first green grayscale value, the dog filter determines the first red grayscale value as the second red grayscale value.

25. The display apparatus for a dog of claim 21, wherein when the first red grayscale value is greater than a first blue grayscale value of the input image data and a first green grayscale value of the input image data is greater than the first blue grayscale value, the dog filter determines the second red grayscale value by subtracting the compensation value from the first red grayscale value,
wherein when the first red grayscale value is greater than the first blue grayscale value and the first green grayscale value is equal to or less than the first blue grayscale value, the dog filter determines the first red grayscale value as the second red grayscale value,
wherein when the first red grayscale value is equal to or less than the first blue grayscale value and the first green grayscale value is greater than the first blue grayscale value, the dog filter determines the first red grayscale value as the second red grayscale value, and
wherein when the first red grayscale value is equal to or less than the first blue grayscale value and the first green grayscale value is equal to or less than the first blue grayscale value, the dog filter determines the first red grayscale value as the second red grayscale value.

26. A display apparatus for a dog comprising:
a display panel including pixels;
a dog filter which generates dog image data based on input image data and determine a second green grayscale value of the dog image data by subtracting a compensation value from a first green grayscale value of the input image data; and
a display panel driver which generates data voltages based on the dog image data and applies the data voltages to the pixels.

27. A display apparatus for a dog comprising:
a display panel including pixels;
a dog filter which generates dog image data by increasing a blue ratio of input image data; and
a display panel driver which generates data voltages based on the dog image data and applies the data voltages to the pixels.

28. The display apparatus for a dog of claim 27, wherein the dog filter converts the input image data in an RGB domain to input image data in an HSV domain, generates a dog image data in the HSV domain by expanding a blue range of a color value of the input image data in the HSV domain and reducing a red range of the color value of the input image data in the HSV domain, and generates the dog image data in the RGB domain based on the dog image data in the HSV domain.

29. A display apparatus for a dog comprising:
a display panel including pixels;
a dog filter which generates dog image data by increasing a difference between a luminance of a red range of input image data and a luminance of a green range of the input image data; and
a display panel driver which generates data voltages based on the dog image data and applies the data voltages to the pixels.

30. A display apparatus for a dog comprising:
a display panel including pixels;
a dog filter which converts input image data to dog recognition image data reflecting visual characteristics of dogs using a conversion table and generate dog image data by compensating the input image data based on a difference between the dog recognition image data and the input image data; and
a display panel driver which generates data voltages based on the dog image data and applies the data voltages to the pixels.
